(19) United States
(12) Patent Application Publication
(10) Pub. No.: US 2015/0140400 A1
(43) Pub. Date: May 21, 2015

(54) POWER STORAGE UNIT AND ELECTRONIC DEVICE INCLUDING THE SAME

(71) Applicant: SEMICONDUCTOR ENERGY LABORATORY CO., LTD., Atsugi-shi (JP)

(72) Inventors: Shunpei YAMAZAKI, Tokyo (JP); Minoru TAKAHASHI, Nagano (JP); Ryota TAJIMA, Isehara (JP)

(21) Appl. No.: 14/529,185

(22) Filed: Oct. 31, 2014

(30) Foreign Application Priority Data
Nov. 15, 2013 (JP) 2013-237205

(51) Int. Cl. H01M 10/04; H01M 2/18

(52) U.S. Cl. CPC H01M 10/0459; H01M 2/18
USPC 429/136

(57) ABSTRACT

A short-circuit between a positive electrode and a negative electrode due to a deposit on an electrode plate is prevented in a power storage unit such as a lithium-ion secondary battery. An electrode plate is covered by a folded insulating sheet. Bonding is performed on facing edges of the sheet which overlap with each other in a portion outer than the electrode plate. One or more openings are formed in the electrode plate, and the facing edges of the folded sheet are bonded to each other also in the opening. Such a bonding portion enables the sheet to be in closer contact with the electrode plate and prevents the displacement between the sheet and the electrode plate. When the electrode plate is deformed or vibrated, the sheet can be rubbed against a surface of the electrode plate, thereby removing a deposit from the surface of the electrode plate.

### TECHNICAL FIELD

The present invention relates to an object, a method, or a manufacturing method. The present invention relates to a process, a machine, manufacture, or a composition of matter. For example, one embodiment of the present invention relates to a power storage unit, a manufacturing method thereof, or the like. For example, one embodiment of the present invention relates to a power storage device, a semiconductor device, a display device, a light-emitting device, a memory device, a driving method thereof, a manufacturing method thereof, or the like.

### BACKGROUND ART

A variety of power storage units such as lithium-ion secondary batteries, lithium-ion capacitors, and air batteries have been actively developed. In particular, with the development of the semiconductor industry, demand for lithium-ion secondary batteries with high output and high energy density (see Patent Document 1, for example) has rapidly grown for electronic devices, for example, portable information terminals such as mobile phones, smartphones, and laptop computers, portable music players, and digital cameras; medical equipment; and the like. The lithium-ion secondary batteries are essential as rechargeable energy supply sources for today's information society.

### REFERENCE

### Patent Document

[Patent Document 1] Japanese Published Patent Application No. 2012-009418

### DISCLOSURE OF INVENTION

The performance required for the lithium-ion secondary batteries includes increased energy density, improved cycle characteristics, safe operation under a variety of environments, and longer-term reliability.

A secondary battery utilizing a metal ion, such as a lithium-ion secondary battery, is a device that performs charge and discharge by electrochemical reaction. When ionized metal moves between a positive electrode and a negative electrode and is reduced to metal again, a needle-like crystal (whisker) of metal is deposited in some cases. The whisker is deposited mainly on the negative electrode. The deposition of the whisker causes a decrease in charge and discharge cycle life. Furthermore, when a whisker grows abnormally and reaches the positive electrode, the positive electrode and the negative electrode are short-circuited.

A secondary battery having a layered structure in which a plurality of electrode plates is stacked is typically known as a structure of a lithium-ion secondary battery. A secondary battery having a layered structure can have high capacity easily by increasing the area of an electrode plate or by increasing the number of stacked electrode plates. Meanwhile, it is necessary to stack a large number of electrodes correctly with separators provided therebetween. For example, when the separator is displaced from the electrode plate, a short circuit might occur. When the separator is creased, a distance between the electrode plates in the portion is large, and thus, electrochemical reaction does not occur uniformly, which causes a problem such as generation of a whisker.

An object of one embodiment of the present invention is to provide a novel power storage unit, a novel manufacturing method thereof, or the like. For example, an object of one embodiment of the present invention is to provide a power storage unit in which a defect is unlikely to occur, a power storage unit which is unlikely to deteriorate, or a power storage unit having high reliability.

Note that the description of a plurality of objects does not mutually preclude the existence. Note that one embodiment of the present invention does not necessarily achieve all the objects listed above. Objects other than those listed above are apparent from the description of the specification, drawings, and claims, and also such objects could be an object of one embodiment of the present invention.

One embodiment of the present invention is a power storage unit including a first electrode plate provided with one or more first openings, a second electrode plate, and a first sheet formed using an insulator. The first electrode plate is covered by the first sheet folded in two, and the facing planes of the first sheet are bonded to each other in at least one of the first openings.

One embodiment of the present invention is a power storage unit including a first electrode plate provided with one or more first openings, a second electrode plate, and two first sheets formed using an insulator. The first electrode plate is covered by the two first sheets, and the two first sheets are bonded to each other in at least one of the first openings.

In the above-described embodiments, the second electrode plate can be provided with one or more second openings. Furthermore, the second electrode plate can be covered by a folded second sheet which is formed using an insulator or by two second sheets which are formed using an insulator.

One embodiment of the present invention can provide a novel power storage unit, a novel manufacturing method thereof, or the like. For example, one embodiment of the present invention can provide a power storage unit in which a defect is unlikely to occur, a power storage unit which is unlikely to deteriorate, or a power storage unit having high reliability.

Note that the description of these effects does not disturb the existence of other effects. In one embodiment of the present invention, there is no need to obtain all the effects. In one embodiment of the present invention, an object other than the above objects, an effect other than the above effects, and a novel feature will be apparent from the description of the specification and the drawings.

### BRIEF DESCRIPTION OF DRAWINGS

FIG. 1 shows a structural example of a power storage unit.

FIG. 2 shows a cross-sectional structure of the power storage unit.

FIG. 3 shows a cross-sectional structure of the power storage unit.

FIGS. 4A to 4E show structural examples of electrode plates.

FIGS. 5A to 5D show a structural example of an envelope body and a manufacturing example of a power storage unit.

FIGS. 6A and 6B show a structural example of an envelope body and a manufacturing example of a power storage unit.

FIGS. 7A to 7D show structural examples of an electrode plate covered by an envelope body.

FIGS. 8A and 8B show structural examples of an envelope body and manufacturing examples of power storage unit.

FIGS. 9A to 9C shows a structural example of a power storage unit and a manufacturing example thereof

FIG. 10 shows a structural example of a power storage unit.

FIG. 11 shows a cross-sectional structure of the power storage unit.

FIG. 12 shows a cross-sectional structure of the power storage unit.

FIGS. 13A to 13D show structural examples of electrode plates.

FIGS. 14A and 14B show a structural example of a power storage unit and a manufacturing example thereof.

FIGS. 15A and 15B show structural examples of an envelope body.

FIGS. 16A to 16E show structural examples of an envelope body.

FIGS. 17A to 17C show structural examples of an envelope body.

FIG. 18 shows a cross-sectional view of a power storage unit.

FIG. 19 shows a cross-sectional view of a power storage unit.

FIG. 20 shows a cross-sectional view of a power storage unit.

FIG. 21 shows a cross-sectional view of a power storage unit.

FIG. 22 shows a cross-sectional view of a power storage unit.

FIG. 23 shows a cross-sectional view of the power storage unit.

FIG. 24 shows a cross-sectional view of a power storage unit.

FIGS. 25A to 25G show structural examples of an electronic device.

FIGS. 26A to 26C show a structural example of an electronic device.

FIG. 27 shows structural examples of an electronic device.

FIGS. 28A and 28B show structural examples of an electronic device.

FIG. 29 shows a cross-sectional structure of a power storage unit.

FIG. 30 shows a cross-sectional structure of a power storage unit.

FIG. 31 shows a cross-sectional structure of a power storage unit.

FIG. 32 shows a cross-sectional structure of a power storage unit.

### BEST MODE FOR CARRYING OUT THE INVENTION

In this specification, a power storage unit is a collective term describing units and devices having a power storage function. Examples of the power storage unit include a battery, a primary battery, a secondary battery, a lithium-ion secondary battery, a lithium-air secondary battery, a capacitor, and a lithium-ion capacitor. Furthermore, an electrochemical device is a collective term describing devices that can function using a power storage unit, a conductive layer, a resistor, a capacitor, and the like. In addition, an electronic device, an electric appliance, a mechanical device, and the like each include a power storage unit according to one embodiment of the present invention in some cases.

Hereinafter, embodiments of the present invention will be described in detail with reference to the accompanying drawings. It will be readily appreciated by those skilled in the art that modes and details of the present invention can be changed in various ways without departing from the spirit and scope of the present invention. Therefore, the present invention should not be construed as being limited to the description of the embodiments below.

A plurality of embodiments of the present invention are described below. Any of the embodiments can be combined as appropriate. In addition, in the case where structural examples are given in one embodiment, any of the structure examples can be combined as appropriate.

A power storage unit of one embodiment of the present invention includes a positive electrode and a negative electrode. The positive electrode and the negative electrode each include one or more electrode plates (positive electrode plates and negative electrode plates) having a sheet-like shape or a flat-plate-like shape. To prevent the occurrence of a short circuit, both surfaces of at least one of two adjacent electrode plates are covered by a sheet (also referred to as a film) made of an insulator. In the following description, a sheet covering the electrode plate is referred to as an “envelope body” in some cases.

### Embodiment 1

In this embodiment, structural examples of a power storage unit, an example of a manufacturing method thereof, and the like are described.

<<Structural Example 1 of Power Storage Unit>>

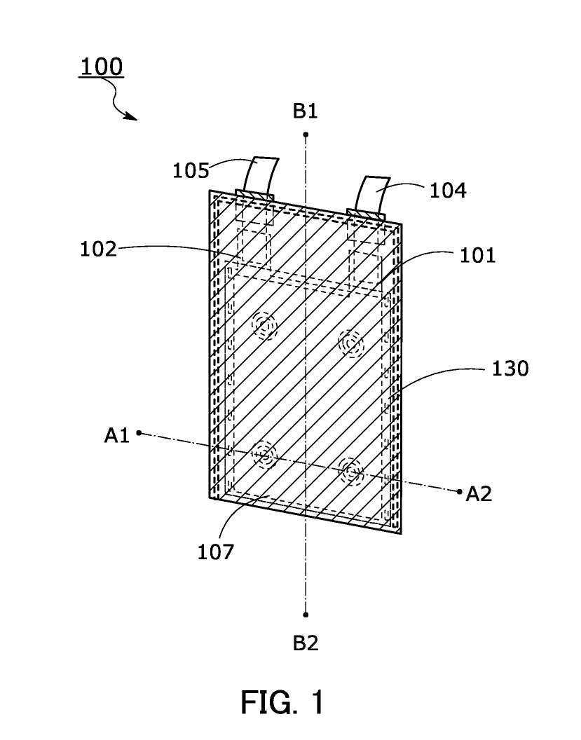

FIG. 1 is an external view showing a structural example of a power storage unit.

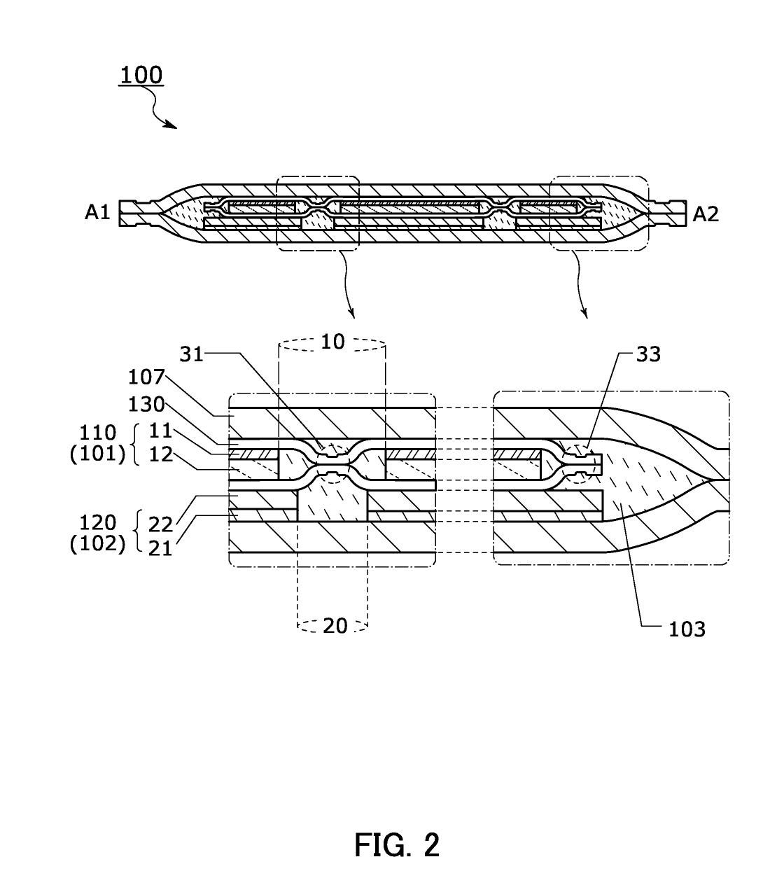

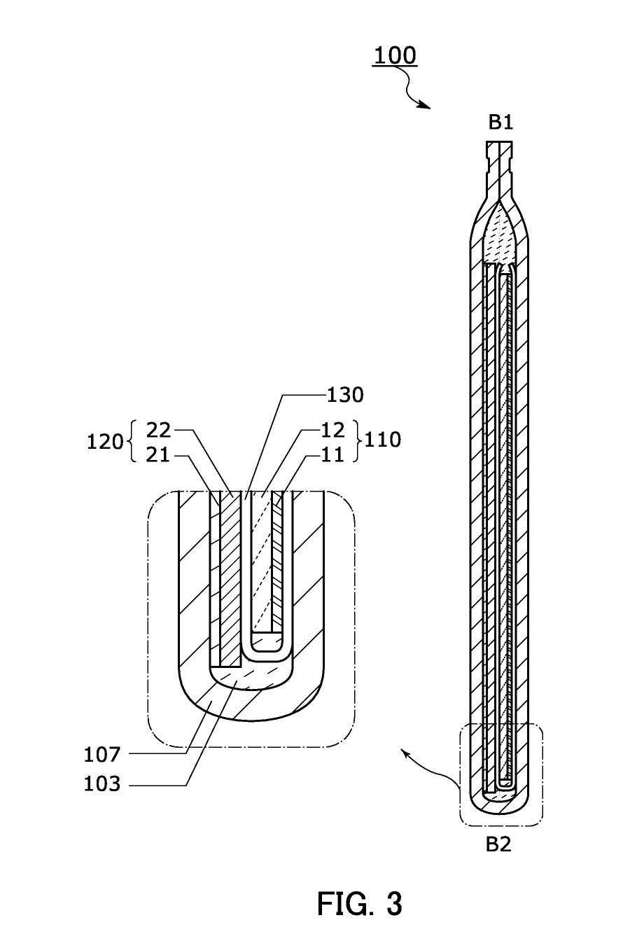

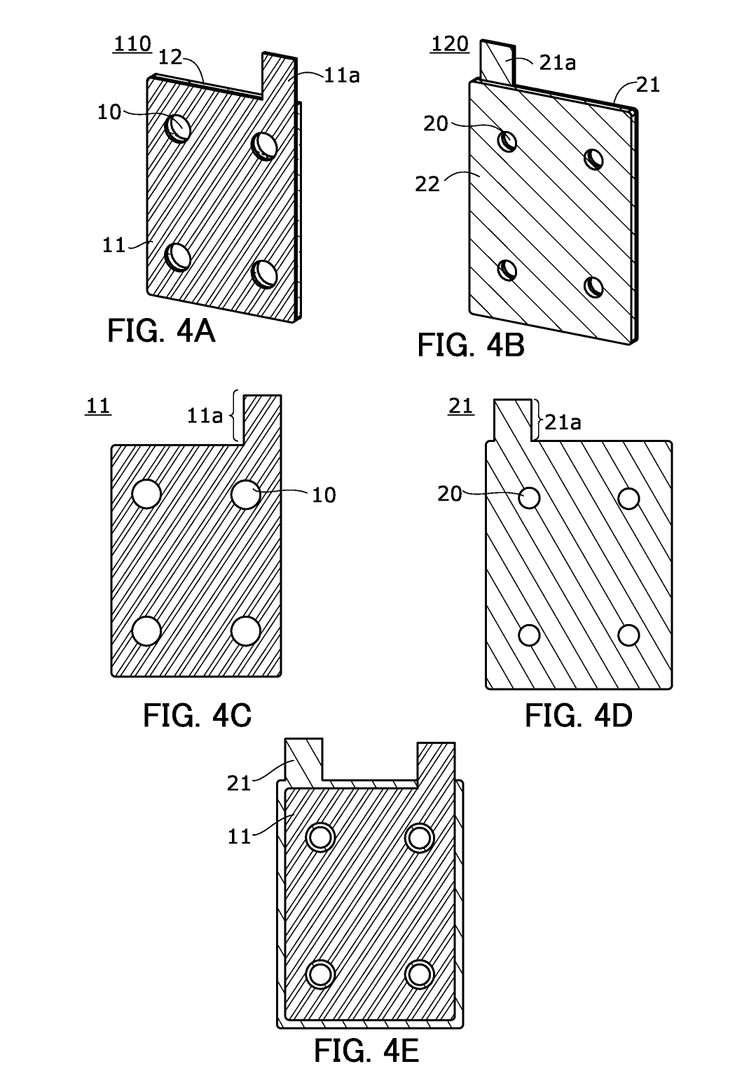

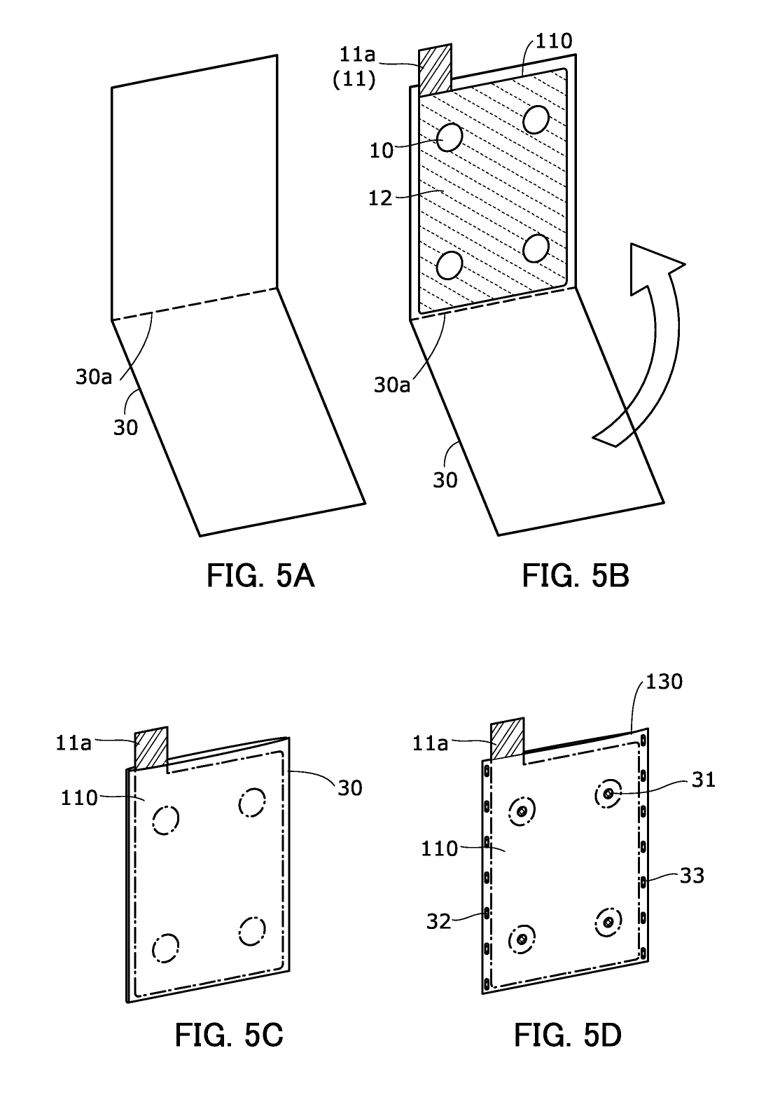

A cross-sectional view along the section line A1-A2 of FIG. 1 is shown in FIG. 2, and a cross-sectional view along the section line B1-B2 of FIG. 1 is shown in FIG. 3. Partially enlarged views are also shown in FIGS. 2 and 3. FIGS. 4A to 4E show structural examples of electrode plates. FIGS. 5A to 5D show a structural example of an envelope body and a manufacturing example thereof.

As illustrated in FIG. 1, a power storage unit 100 includes a positive electrode 101, a negative electrode 102, a positive electrode lead 104, a negative electrode lead 105, and an exterior body 107. The positive electrode 101, the negative electrode 102, and an electrolyte solution 103 are sealed in the exterior body 107. The positive electrode 101 and the negative electrode 102 are electrically connected to the positive electrode lead 104 and the negative electrode lead 105, respectively. The power storage unit 100 is charged and discharged through the positive electrode lead 104 and the negative electrode lead 105. The lead is also referred to as a lead electrode, a terminal, a lead terminal, or the like.

A structural example in which one electrode plate (a positive electrode plate 110 or a negative electrode plate 120) is included in each of the positive electrode 101 and the negative electrode 102 and only the positive electrode plate 110 is covered by an envelope body 130 is described here for easy understanding of this embodiment. It is needless to say that one embodiment of the present invention is not limited thereto. Only the negative electrode plate 120 may be covered by the envelope body 130, or each of the positive electrode plate 110 and the negative electrode plate 120 may be covered by the envelope body 130.

<Electrode Plate>

For example, as shown in FIGS. 4A and 4B, the positive electrode plate 110 and the negative electrode plate 120 have similar structures. The positive electrode plate 110 includes a positive electrode current collector 11 and a positive electrode active material layer 12. The negative electrode plate 120 includes a negative electrode current collector 21 and a negative electrode active material layer 22.

The positive electrode current collector 11 is provided with a tab 11a which is a connection portion for connection to the positive electrode lead 104 (FIG. 4C). In the case where the positive electrode 101 includes a plurality of positive electrode plates 110, the tab 11a also serves as a connection portion for connection between the positive electrode plates 110. Like the positive electrode current collector 11, the negative electrode current collector 21 is provided with a tab 21a (FIG. 4D). The positive electrode active material layer 12 is formed on one surface of the positive electrode current collector 11 (FIG. 4A). The negative electrode active material layer 22 is formed on one surface of the negative electrode current collector 21 (FIG. 4B). The positive electrode active material layer 12 and the negative electrode active material layer 22 are not formed on the tab 11a and the tab 21a. However, the active material layers (12 and 22) can be formed on regions of the tab 11a and 21a that overlap with the envelope body 130.

A plurality of openings 10 is formed in the positive electrode plate 110. The openings 10 pass through regions where the positive electrode active material layer 12 exists. In the case where the openings 10 are used to fix the envelope body 130 to the positive electrode plate 110, the number of the openings 10 is preferably two or more so that parallel or rotational displacement of the envelope body 130 can be prevented. In this example, four openings 10 are provided in the positive electrode plate 110. Although each opening 10 has a circular shape in this example, the shape of the opening 10 is not limited thereto. Each opening 10 preferably has a shape that relieves the concentration of stress and is obtained by simple processing. A circular shape is given as an example of such a shape. Openings 20 are similarly provided in the negative electrode plate 120.

FIG. 4E is a plan view showing a state where the positive electrode plate 110 and the negative electrode plate 120 are stacked. Only the current collectors (11 and 21) are shown in the drawing. The size (length and width) of the outside shape of the negative electrode current collector 21 is larger than that of the outside shape of the positive electrode current collector 11, and the peripheral end portion of the positive electrode current collector 11 (the positive electrode plate 110) exists over a surface of the negative electrode current collector 21 (the negative electrode plate 120) when the positive electrode plate 110 and the negative electrode plate 120 are stacked. Such a structure can relieve the concentration of an electric field in the peripheral end portion of the negative electrode plate 120 and can prevent a dendrite from being deposited in the region. As in the example shown in FIG. 4E, in the case where the positive electrode plate 110 overlaps with the negative electrode plate 120 so that the openings 10 and 20 overlap with each other, the diameter of the opening 20 is smaller than that of the opening 10 for a similar reason.

The size of the outside shape of the positive electrode plate 110 can be increased so that the negative electrode current active material layer 22 surely faces and overlaps with the positive electrode current collector 11. In this case, the diameter of the opening 20 in the negative electrode plate 120 may be larger than that of the opening 10. Alternatively, the positive electrode plate 110 and the negative electrode plate 120 can have the same shape and the same size. The openings 10 and 20 can be formed at the same position and can have the same size.

In the example shown in FIG. 4E, the openings 10 and 20 are provided to form a hole passing through an electrode stack in which the positive electrode plate 110 and the negative electrode plate 120 are stacked. When the openings 10 and 20 are provided in this manner, a decrease in capacity of the power storage unit 100 due to formation of the openings 10 and 20 can be suppressed. Furthermore, the positive electrode plate 110 and the negative electrode plate 120 are aligned easily. The through hole passing through the electrode stack serves as a path through which a fluid (e.g., a liquid or a gas) passes in the exterior body 107; thus, the envelope body 130 can be impregnated with the electrolyte solution 103 more sufficiently even in a power storage unit in which a large number of electrode plates is stacked.

In the example shown in FIG. 4E, four through holes each composed of the opening 10 and the opening 20 overlapping with each other are provided; however, one embodiment of the present invention is not limited to this example. The openings 10 and 20 are preferably provided so that at least one through hole exists in the electrode stack. One of the positive electrode plate 110 and the negative electrode plate 120 is not necessarily provided with the opening 10 or 20.

In the case where facing planes of the envelope body 130 are bonded to each other in the opening 10 or 20 as described below, each of the openings 10 and 20 may have a size that is enough to perform the bonding therein. The diameter of each of the openings 10 and 20 can be approximately several millimeters; for example, the diameter is greater than or equal to 1 mm and less than or equal to 8 mm, preferably greater than or equal to 2 mm and less than or equal to 5 mm. Note that in the case where the shape of each of the openings 10 and 20 is not circle, the diameter of a circumcircle of each of the openings 10 and 20 is preferably set to be greater than or equal to 2 mm and less than or equal to 5 mm. The size and the number of the openings can be determined with the battery capacity taken into account because the capacity of the power storage unit 100 is decreased by providing the openings 10 and 20. The proportion of the total area of all the openings 10 to the area of the positive electrode plate 110 (specifically, the area of a region where the positive electrode active material layer 12 is formed) is preferably less than or equal to 5%, more preferably less than or equal to 3%, still more preferably less than or equal to 1%.

The electrode plates (110 and 120) may each include a component other than the current collector and the active material layer. Described below are components included in the electrode plates (110 and 120), materials thereof, and the like.

[Positive Electrode Current Collector]

The positive electrode current collector 11 can be formed using a material that has high conductivity and is not alloyed with a carrier ion of lithium or the like, such as stainless steel, gold, platinum, aluminum, or titanium, an alloy thereof, or the like. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. As the positive electrode current collector 11, a material having a foil-like shape, a plate-like shape, a sheet-like shape, a net-like shape, a punching-metal shape, an expanded-metal shape, or the like can be used as appropriate. The positive electrode current collector 11 preferably has a thickness greater than or equal to 5 μm and less than or equal to 30 μm, for example. The surface of the positive electrode current collector 11 may be provided with an undercoat made of graphite or the like.

[Positive Electrode Active Material Layer]

The positive electrode active material layer 12 may further include a binder for increasing adhesion of positive electrode active materials, a conductive additive for increasing the conductivity of the positive electrode active material layer 12, and the like in addition to the positive electrode active material.

Examples of the positive electrode active material include a composite oxide with an olivine crystal structure, a composite oxide with a layered rock-salt crystal structure, and a composite oxide with a spinel crystal structure. As the positive electrode active material, a compound such as LiFeO₂, LiCoO₂, LiNiO₂, LiMn₂O₄, V₂O₅, Cr₂O₅, and MnO₂ is used.

LiCoO₂ is particularly preferable because it has high capacity, stability in the air higher than that of LiNiO₂, and thermal stability higher than that of LiNiO₂, for example.

It is preferable to add a small amount of lithium nickel oxide (LiNiO₂ or LiNi₁₋ₓMO₂ (M=Co, Al, or the like)) to a compound with a spinel crystal structure which contains manganese such as LiMn₂O₄ because the elution of manganese and the decomposition of an electrolyte solution can be suppressed, for example.

Alternatively, a complex material (LiMPO₄ (general formula) (M is one or more of Fe(II), Mn(II), Co(II), and Ni(II))) can be used as the positive electrode active material. Typical examples of the general formula LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b ≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly satisfies conditions necessary for the positive electrode active material, such as safety, stability, high capacity density, high potential, and the existence of lithium ions which can be extracted in initial oxidation (charging).

Alternatively, a complex material such as Li(₂₁)MSiO₄ (general formula) (M is one or more of Fe(II), Mn(II), Co(II), and Ni(II); 0≦j≦2) may be used as the positive electrode active material. Typical examples of the general formula Li₍₂₋ⱼ₎MSiO₄ are lithium compounds such as Li₍₂₋ⱼ₎FeSiO₄, Li₍₂₋ⱼ₎NiSiO₄, Li₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄(m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t <1, and 0<u<1).

Still alternatively, a nasicon compound expressed by AₓM₂(XO₄)₃ (general formula) (A=Li, Na, or Mg, M=Fe, Mn, Ti, V, Nb, or Al, X=S, P, Mo, W, As, or Si) can be used as the positive electrode active material. Examples of the nasicon compound are Fe₂(MnO₄)₃, Fe₂(SO₄)₃, and Li₃Fe₂(PO₄)₃. Still further alternatively, compounds represented by a general formula, Li₂MPO₄F, Li₂MP₂O₇, and Li₅MO₄ (M=Fe or Mn), a perovskite fluoride such as NaFeF₃ and FeF₃, a metal chalcogenide (a sulfide, a selenide, and a telluride) such as TiS₂ and MoS₂, an oxide with an inverse spinel crystal structure such as LiMVO₄, a vanadium oxide (e.g., V₂O₅, V₆O₁₃, and LiV₃O₈), a manganese oxide, and an organic sulfur compound can be used as the positive electrode active material, for example.

In the case where carrier ions are alkaline-earth metal ions or alkali metal ions other than lithium ions, the positive electrode active material may contain, instead of lithium in the above lithium compound, lithium-containing complex phosphate, lithium-containing complex silicate, or the like, an alkali metal (e.g., sodium or potassium) or an alkaline-earth metal (e.g., calcium, strontium, barium, beryllium, or magnesium). For example, the positive electrode active material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active material. For example, a solid solution containing any of the aforementioned materials, e.g., a solid solution containing LiCo_{1/3}Mn_{1/3}Ni_{1/3}O₂ and Li₂MnO₃ may be used.

A carbon layer or an oxide layer such as a zirconium oxide layer may be provided on a surface of the positive electrode active material layer 12. The carbon layer or the oxide layer increases the conductivity of an electrode. The positive electrode active material layer 12 can be coated with the carbon layer by mixing a carbohydrate such as glucose at the time of baking the positive electrode active material.

The average particle diameter of the primary particle of the positive electrode active material layer 12 is preferably greater than or equal to 50 nm and less than or equal to 100 μm.

Examples of the conductive additive include acetylene black (AB), graphite (black lead) particles, carbon nanotubes, graphene, and fullerene.

A network for electron conduction can be formed in the positive electrode 101 by the conductive additive. The conductive additive also allows maintaining of a path for electric conduction between the particles of the positive electrode active material layer 12. The addition of the conductive additive to the positive electrode active material layer 12 increases the electron conductivity of the positive electrode active material layer 12.

Graphene has an excellent electrical characteristic of high conductivity and excellent physical properties of high flexibility and high mechanical strength. Furthermore, graphene can be used as the conductive additive of the negative electrode active material layer 22. The use of graphene as the conductive additive can increase contact points and the contact area of particles of an active material.

As the binder, instead of polyvinylidene fluoride (PVDF) as a typical one, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose or the like can be used.

The content of the binder in the positive electrode active material layer 12 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the positive electrode active material layer 12 is preferably greater than or equal to 1 wt % and less than or equal to 10 wt %, more preferably greater than or equal to 1 wt % and less than or equal to 5 wt %.

[Negative Electrode Current Collector]

The negative electrode current collector 21 can be formed using a material that has high conductivity and is not alloyed with a carrier ion of lithium or the like, such as stainless steel, gold, platinum, zinc, iron, copper, titanium, or tantalum, an alloy thereof, or the like. Alternatively, an aluminum alloy to which an element which improves heat resistance, such as silicon, titanium, neodymium, scandium, and molybdenum, is added can be used. Further alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 21 can have a foil-like shape, a plate-like shape (sheet-like shape), a net-like shape, a punching-metal shape, an expanded-metal shape, or the like as appropriate. The negative electrode current collector 21 preferably has a thickness greater than or equal to 5 μm and less than or equal to 30 μm. The surface of the negative electrode current collector 21 may be provided with an undercoat using graphite or the like.

[Negative Electrode Active Material Layer]

The negative electrode active material layer 22 may further include a binder for increasing adhesion of negative electrode active materials, a conductive additive for increasing the conductivity of the negative electrode active material layer 22, and the like in addition to the negative electrode active material.

There is no particular limitation on the material of the negative electrode active material layer 22 as long as it is a material with which lithium can be dissolved and precipitated or a material into/from which lithium ions can be inserted and extracted. Other than a lithium metal or lithium titanate, a carbon-based material generally used in the field of a power storage unit, or an alloy-based material can also be used as the negative electrode active material layer 22.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like. Examples of the graphite include artificial graphite such as meso-carbon microbeads (MCMB), coke-based artificial graphite, or pitch-based artificial graphite and natural graphite such as spherical natural graphite. Graphite has a low potential substantially equal to that of a lithium metal (0.1 V to 0.3 V vs. Li/Li⁺) when lithium ions are inserted into the graphite (when a lithium-graphite intercalation compound is formed). For this reason, a lithium ion battery can have a high operating voltage. In addition, graphite is preferable because of its advantages such as relatively high capacity per unit volume, small volume expansion, low cost, and safety greater than that of a lithium metal.

For the negative electrode active material, an alloy-based material or oxide which enables charge-discharge reaction by an alloying reaction and a dealloying reaction with lithium can be used. In the case where lithium ions are carrier ions, the alloy-based material is, for example, a material containing at least one of Mg, Ca, Al, Si, Ge, Sn, Pb, As, Sb, Bi, Ag, Au, Zn, Cd, Hg, In, and the like. Such elements have higher capacity than carbon. In particular, silicon has a theoretical capacity of 4200 mAh/g, which is significantly high. For this reason, silicon is preferably used as the negative electrode active material. Examples of the alloy-based material using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the oxide for the negative electrode active material, SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), molybdenum oxide (MoO₂), or the like can be used.

Still alternatively, as the negative electrode active material, Li₃₋ₓM,N (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Still further alternatively, as the negative electrode active material, a material which causes conversion reaction can be used. For example, a transition metal oxide with which an alloying reaction with lithium is not caused, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as the positive electrode active material because of its high potential.

Graphene may be formed on a surface of the negative electrode active material. For example, in the case of using silicon as the negative electrode active material, the volume of silicon is greatly changed due to occlusion and release of carrier ions in charge-discharge cycles. Thus, adhesion between the negative electrode current collector 21 and the negative electrode active material layer 22 is decreased, resulting in degradation of battery characteristics caused by charge and discharge. In view of this, graphene is preferably formed on a surface of the negative electrode active material containing silicon because even when the volume of silicon is changed in charge-discharge cycles, separation between the negative electrode current collector 21 and the negative electrode active material layer 22 can be prevented, which makes it possible to reduce degradation of battery characteristics.

Further, a coating film of oxide or the like may be formed on the surface of the negative electrode active material. A coating film formed by decomposition or the like of an electrolyte solution or the like in charging cannot release electric charges used at the formation, and therefore forms irreversible capacity. In contrast, the film of an oxide or the like provided on the surface of the negative electrode active material in advance can reduce or prevent generation of irreversible capacity.

As the coating film coating the negative electrode active material, an oxide film of any one of niobium, titanium, vanadium, tantalum, tungsten, zirconium, molybdenum, hafnium, chromium, aluminum, and silicon or an oxide film containing any one of these elements and lithium can be used. Such a film is denser than a conventional film formed on a surface of a negative electrode due to a decomposition product of an electrolyte solution.

For example, niobium pentoxide (Nb₂O₅) has a low electric conductivity of 10⁻⁹ S/cm and a high insulating property. For this reason, a niobium oxide film inhibits electrochemical decomposition reaction between the negative electrode active material and the electrolyte solution. On the other hand, niobium oxide has a lithium diffusion coefficient of 10⁻⁹ cm²/sec and high lithium ion conductivity. Therefore, niobium oxide can transmit lithium ions. Alternatively, silicon oxide or aluminum oxide may be used.

A sol-gel method can be used to coat the negative electrode active material with the coating film, for example. The sol-gel method is a method for forming a thin film in such a manner that a solution of metal alkoxide, a metal salt, or the like is changed into a gel, which has lost its fluidity, by hydrolysis reaction and polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solvent, the active material can be easily dispersed into the gel. In such a manner, the coating film can be formed on the surface of the negative electrode active material. A decrease in the capacity of the power storage unit can be prevented by using the coating film.

<Formation of Electrode Plate>

The positive electrode active material layer 12 can be formed by a coating method or the like. For example, a positive electrode active material, a binder, and a conductive additive are mixed to form a positive electrode paste (slurry). Foil (e.g., aluminum foil) made of a conductor included in the positive electrode current collector 11 is coated with the positive electrode paste, and drying is performed. The aluminum foil on which the positive electrode active material layer 12 is formed is processed into a shape like that shown in FIG. 4C. In this step, the opening 10 is formed. The processing may be performed using a punching device, for example. Through the above steps, the positive electrode plate 110 can be formed. The negative electrode plate 120 can be formed in a similar manner. The negative electrode current collector 21 is formed using copper foil, for example.

<Envelope Body>

As shown in FIG. 5A, the envelope body 130 can be formed using a sheet 30 which is made of an insulator and is folded in two. As the sheet 30, a sheet formed using a porous insulator such as polypropylene (PP), polyethylene (PE), polybutene, nylon, polyester, polysulfone, polyacrylonitrile, polyvinylidene fluoride, or tetrafluoroethylene can be used. Furthermore, nonwoven fabric formed using fiber made of an insulating material (glass fiber, high-molecular fiber, or cellulose) can be used. The sheet 30 may be a sheet including a stack of a plurality of sheets. A surface of the sheet 30 may be coated with a resin material or the like to increase heat resistance and hydrophilicity thereof.

The thickness of the sheet 30 is greater than or equal to 10 μm and less than or equal to 100 μm, for example. In order to increase the effect of removing a deposit on surfaces of the positive electrode plate 110 and the negative electrode plate 120 by the envelope body 130, the thickness of the sheet 30 is preferably greater than or equal to 30 μm, more preferably greater than or equal to 50 μm. For example, the thickness may be greater than or equal to 80 μm and less than or equal to 100 μm.

A method for forming the envelope body 130 fixed to the positive electrode plate 110 is described with reference to FIGS. 5A to 5D. The positive electrode plate 110 is made to overlap with the sheet 30 (FIG. 5B). Then, the sheet 30 is folded along a portion 30a indicated by a dotted line, and the positive electrode plate 110 is provided between facing planes of the sheet 30 (FIG. 5C). Thus, a state where both surfaces (a top surface and a bottom surface) of the positive electrode plate 110 are covered by the sheet 30 is produced. To maintain the state, in regions where the facing planes of the sheet 30 directly overlap with each other (i.e., in the openings 10 and a portion outer than the positive electrode plate 110), a part of the sheet 30 is bonded to another part of the sheet 30. Through the above steps, the envelope body 130 is completed. Examples of a method for the bonding include welding by heating, ultrasonic welding, and adhesion using an adhesive. The bonding method may be selected as appropriate according to materials of the sheet 30, the electrolyte solution 103, and the like.

In the example shown in FIG. 5D, the envelope body 130 includes a bonding portion 31, a bonding portion 32, and a bonding portion 33. As shown in FIG. 2, the bonding portion 31 is a portion where the sheet 30 is fixed in the opening 10, and the bonding portions 32 and 33 are portions where outer edges of the sheet 30 are fixed. Fixing the envelope body 130 (the sheet 30) in the opening 10 enables the envelope body 130 to be in closer contact with the positive electrode plate 110. Thus, the positive electrode plate 110 in the envelope body 130 can be prevented from being shifted too much. Furthermore, the envelope body 130 can be prevented from being creased. An effect given by the formation of the bonding portion 31 is increased as the size of the electrode plates is increased. As the size of the electrode plates is increased, the proportion of a decrease in the electrode area due to the opening is reduced under the conditions where the area of the opening is the same. On the other hand, as the area of the positive electrode plate and the negative electrode plate increases, it becomes difficult to align them. To fix the sheet (the envelope body) made of an insulator at the openings formed in the electrode plates is very effective in improving the performance, the reliability, the safety, and the like of a power storage unit having high capacity.

The amount of movement of the positive electrode plate 110 in the envelope body 130 is small, and the positive electrode plate 110 is in close contact with the envelope body 130. Thus, when the positive electrode plate 110 is deformed or moved (or vibrated, for example), a surface of the positive electrode plate 110 can be rubbed by the envelope body 130, so that a deposit on the surface of the positive electrode plate 110 can be removed by the envelope body 130. Accordingly, the charge/discharge cycle characteristics of the power storage unit 100 can be improved. Because the deposit can be removed before it grows abnormally, the positive electrode 101 and the negative electrode 102 can be prevented from being short-circuited. Although the negative electrode plate 120 is not covered by the envelope body 130, the negative electrode plate 120 is in contact with the envelope body 130 covering the positive electrode plate 110. When the envelope body 130 is slid, a surface of the negative electrode plate 120 is rubbed, so that a deposit on the negative electrode plate 120 can also be removed.

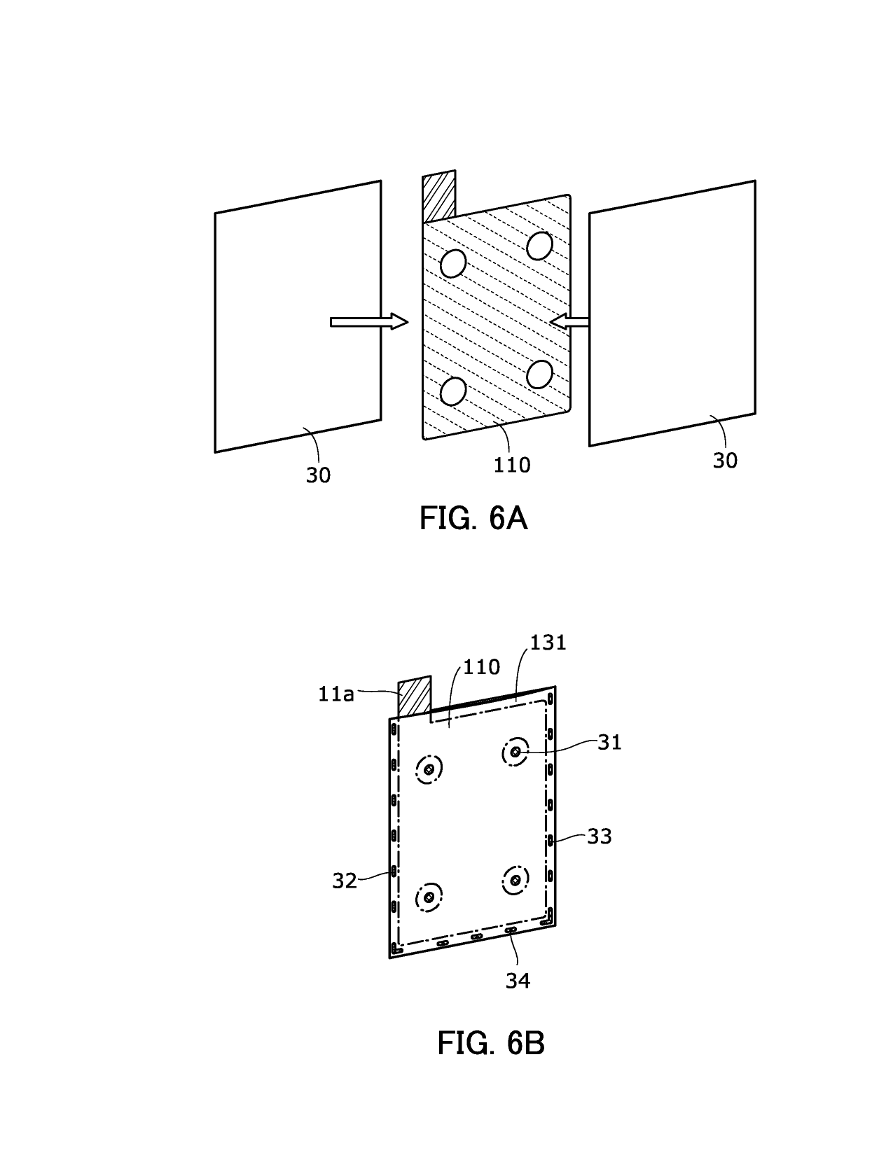

The envelope body is formed of one sheet in the example shown in FIGS. 5A to 5D, but the envelope body may be formed of two sheets. The positive electrode plate 110 is provided between two sheets 30 (FIG. 6A). The two sheets 30 are bonded to each other to complete an envelope body 131 (FIG. 6B). In the example shown in FIG. 6B, the bonding portions 31, 32, and 33 are formed in the envelope body 131 as in the envelope body 130. Furthermore, a bonding portion 34 is formed in a portion corresponding to the portion 30a of the sheet 30 shown in FIG. 5A.

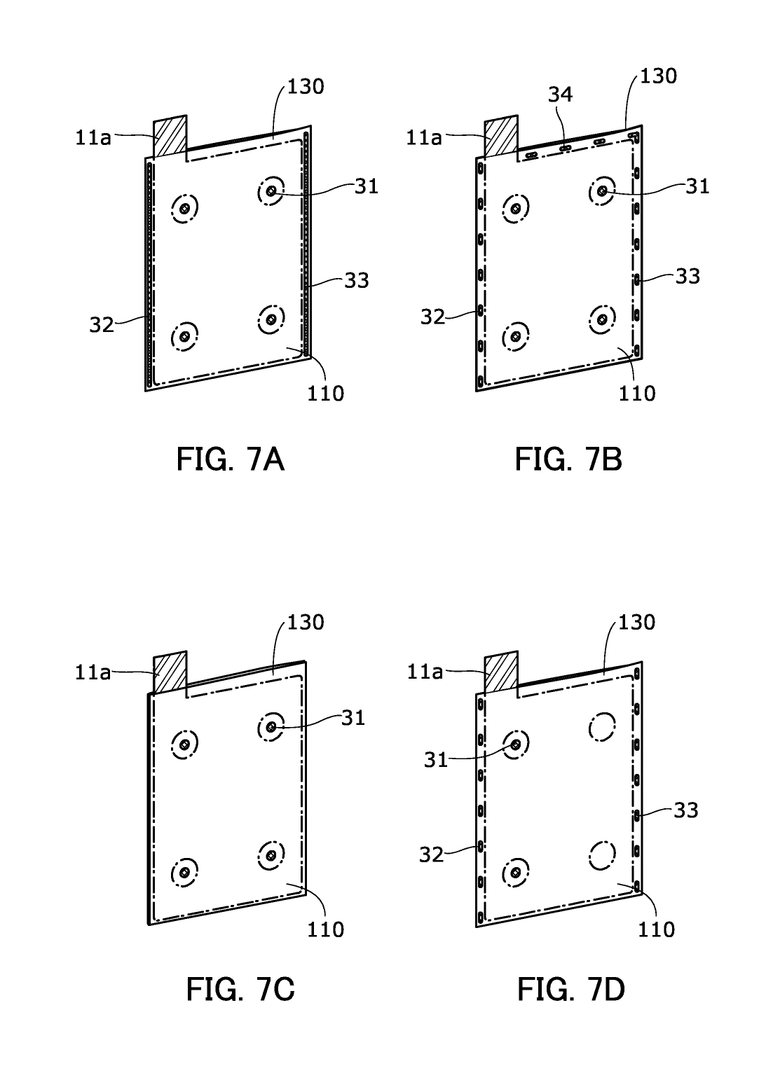

Note that the bonding portions provided to form the sheet(s) 30 into an envelope shape (bag-like shape) are not limited to those shown in FIG. 5D and FIG. 6B. It is only necessary that the envelope bodies 130 and 131 be formed so that the positive electrode plate 110 is covered by the one sheet 30 or the two sheets 30. Some structural examples thereof are described below with reference to FIGS. 7A to 7D. The bonding portions 32 and 33 may be formed so that openings are not left in the outer edges of the envelope body 130 (FIG. 7A). The bonding portion 34 may be formed in an outer edge of the envelope body 130 where the tab 11a exists (FIG. 7B). The envelope body 130 may be fixed to the positive electrode plate 110 only by the bonding portions 31 without forming the bonding portions 32 and 33 (FIG. 7C). In this case, a region where the bonding portions 32 and 33 are formed is not needed; thus, the size of the sheet 30 can be reduced. A structure in which the bonding portions 31 are provided in some of the openings 10 and the bonding portions 31 are not provided in the other of the openings 10 can be employed (FIG. 7D).

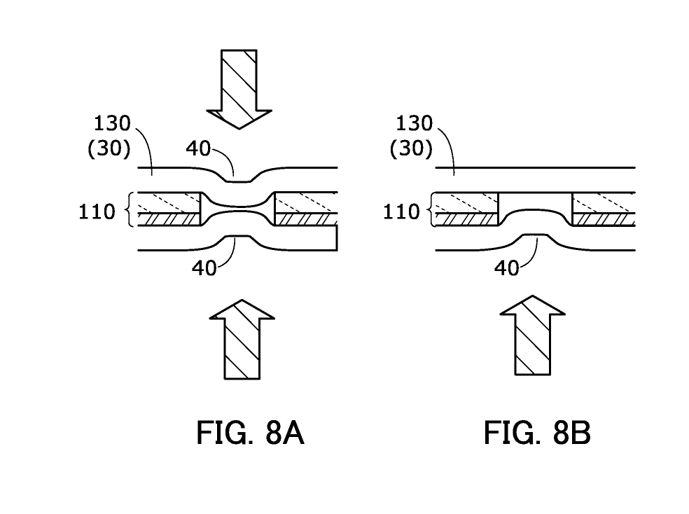

In the case where the bonding portions 31 for fixing the sheet 30 cannot be provided because of limitations on the thickness and the material of the sheet 30, the size of the opening 10, and the like, the envelope body 130 may be provided with a depression 40 in the opening 10. For example, opposite surfaces or one surface of the envelope body 130 (the sheet 30) is pressed with a jig or the like to form the depression 40 (FIGS. 8A and 8B). Such structures may be employed in the case where the sheet 30 is formed using nonwoven fabric having a thickness of 50 μm or more, for example. By forming the depression 40, an excess part of the envelope body 130 is depressed in the opening 10; thus, the envelope body 130 can be in closer contact with the positive electrode plate 110 even when the sheets 30 are not bonded to each other in the opening 10.

The negative electrode plate 120 can be fixed to the envelope body 130 in a manner similar to that of the positive electrode plate 110. In the power storage unit 100, at least one of the positive electrode plate 110 and the negative electrode plate 120 may be fixed to the envelope body 130.

In the case where each of the positive electrode plate and the negative electrode plate is covered by the envelope body, an effect of preventing a short circuit between the electrode plates is increased. In the case where one of the positive electrode plate and the negative electrode plate is covered by the envelope body, the power storage unit can be reduced in thickness and weight as compared to the case where each of the positive electrode plate and the negative electrode plate is covered in the envelope body. For example, in the aging step where charge and discharge are performed on the manufactured power storage unit 100, gas is generated from the negative electrode plate 120 more easily than from the positive electrode plate 110. Therefore, in order to release the gas easily, only the positive electrode plate 110 may be covered. Furthermore, by repetition of charge and discharge of the power storage unit 100 in use, a deposit that deteriorates the characteristics of the power storage unit 100 is formed on the negative electrode plate 120 more easily than on the positive electrode plate 110. For example, in the case of a lithium ion secondary battery, a lithium whisker is formed on the negative electrode plate 120. In order to remove the deposit from the negative electrode plate 120 more effectively, the negative electrode plate 120 is preferably fixed to the envelope body 130.

<Electrode Stack>

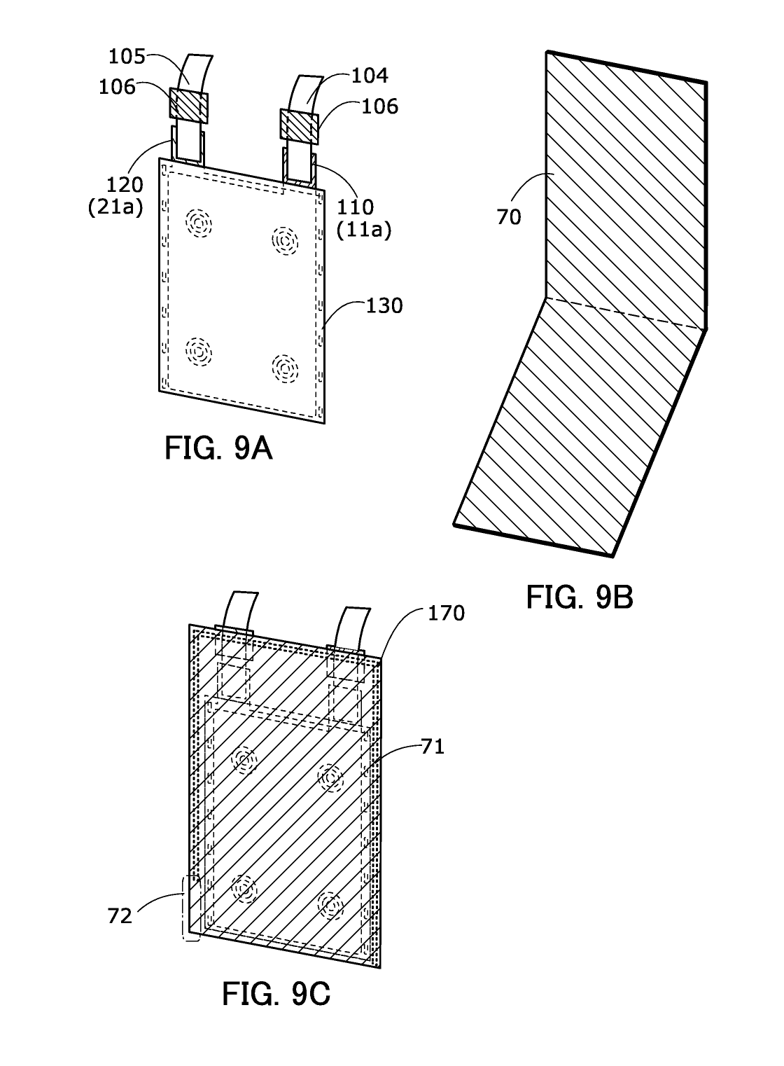

The negative electrode plate 120 and the positive electrode plate 110 fixed to the envelope body 130 are stacked (FIG. 2 and FIG. 3). Whether the negative electrode plate 120 and the positive electrode plate 110 are surely stacked may be examined observing overlap of the openings 10 and 20. After the positive electrode plate 110 and the negative electrode plate 120 are stacked, the positive electrode lead 104 is connected to the tab 11a of the positive electrode plate 110, and the negative electrode lead 105 is connected to the tab 21a of the negative electrode plate 120 (FIG. 9A). The tab (11a or 21a) may be connected to the lead (104 or 105) by ultrasonic welding, for example. Here, a lead provided with a sealant layer 106 is used as the lead (104 or 105).

<Exterior Body>

Next, the positive electrode plate 110 and the negative electrode plate 120 which are stacked are enclosed in the exterior body 107. Here, the exterior body 107 is formed by folding one film 70 into the shape of a bag (FIG. 9B). The film 70 used for the exterior body 107 is a single-layer film selected from a metal film (e.g., an aluminum film, a stainless steel film, and a nickel steel film), a plastic film made of an organic material, a hybrid material film including an organic material (e.g., an organic resin or fiber) and an inorganic material (e.g., ceramic), and a carbon-containing film (e.g., a carbon film or a graphite film); or a stacked-layer film including two or more of the above films. The film 70 may be provided with a depression and/or a projection, which increases the surface area of the film 70 and accordingly intensifies an effect of releasing heat from the exterior body 107. The depression and/or the projection can be formed by embossing, for example.

In the case where the power storage unit 100 is changed in form, bending stress is applied to the exterior body 107. This might partly deform or damage the exterior body 107. The depression and/or projection formed on the surface of the exterior body 107 can relieve a strain due to stress generated in the exterior body 107. Therefore, the power storage unit 100 can have high reliability. A “strain” is the scale of change in form indicating the displacement of a point of an object relative to the reference (initial) length of the object.

The film 70 is folded, so that a state shown in FIG. 9C is produced. Then, outer facing edges of the film 70 except an introduction port 72 for the electrolyte solution 103 are bonded to each other by thermocompression bonding to form the exterior body 107. Reference numeral 71 denotes a bonding portion of the film 70. In the thermocompression bonding step, the sealant layers 106 of the leads (104 and 105) are melted, so that the leads (104 and 105) are bonded to the film 70.

<Electrolyte Solution>

The electrolyte solution 103 is injected to the inside of the exterior body 107 through the introduction port 72 in a reduced-pressure atmosphere or in an inert atmosphere. Owing to the openings 10 and 20 formed in the positive electrode plate 110 and the negative electrode plate 120, the electrolyte solution 103 and gas in the exterior body 107 can be exchanged smoothly, and the inside of the exterior body 107 can be wholly filled up with the electrolyte solution 103 with ease. Thus, the envelope body 130 can be sufficiently impregnated with the electrolyte solution 103.

Furthermore, because the envelope body 130 is fixed to the positive electrode plate 110, the envelope body 130 can be prevented from being creased in the injecting process. As the number of the stacked electrode plates (110 and 120) and the areas of the electrode plates (110 and 120) are increased, the existence of the openings 10 and 20 becomes much more effective.

As the electrolyte solution 103, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled high-molecular material is used as the solvent for the electrolyte solution, safety against liquid leakage and the like is improved. Further, a secondary battery can be thinner and more lightweight. Typical examples of the gelled high-molecular material include a silicone gel, an acrylic gel, an acrylonitrile gel, polyethylene oxide, polypropylene oxide, a fluorine-based polymer, and the like.

Alternatively, the use of one or more ionic liquids (room temperature molten salts) which are less likely to burn and volatilize as the solvent of the electrolyte solution 103 can prevent the power storage unit from exploding or catching fire even when the power storage unit internally shorts out or the internal temperature increases due to overcharging or the like.

As an electrolyte dissolved in the above-described solvent, in the case of using lithium ions as carrier ions, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃ SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution 103 preferably contains a small amount of dust particles and elements other than the constituent elements of the electrolyte solution (hereinafter, also simply referred to as impurities) so as to be highly purified. Specifically, the weight ratio of impurities to the electrolyte solution is less than or equal to 1%, preferably less than or equal to 0.1%, and more preferably less than or equal to 0.01%. An additive agent such as vinylene carbonate may be added to the electrolyte solution 103.

<Aging Step>

The introduction port 72 is temporarily sealed. Then, an aging step is performed so that the power storage unit 100 can be actually used. In the aging step, a set of charge and discharge is performed once or more than once, for example. When the power storage unit 100 is charged, part of the electrolyte solution 103 is decomposed and gas is generated in some cases. Therefore, after finishing the aging step, the sealed introduction port 72 is opened to release the gas generated in the exterior body 107. Because the gas moves through the openings (10 and 20) of the electrode plates (110 and 120), the gas can be released smoothly even in the case where the number of stacked electrode plates (110 and 120) is increased.

<Sealing of Exterior Body>

After the degasification, the electrolyte solution 103 may be added into the power storage unit 100 to compensate for the decomposed electrolyte solution. Furthermore, a set of the aging step and the degasification step may be performed twice or more than twice. Then, the introduction port 72 is sealed. Thus, the power storage unit 100 which can be actually used is completed (FIG. 1).

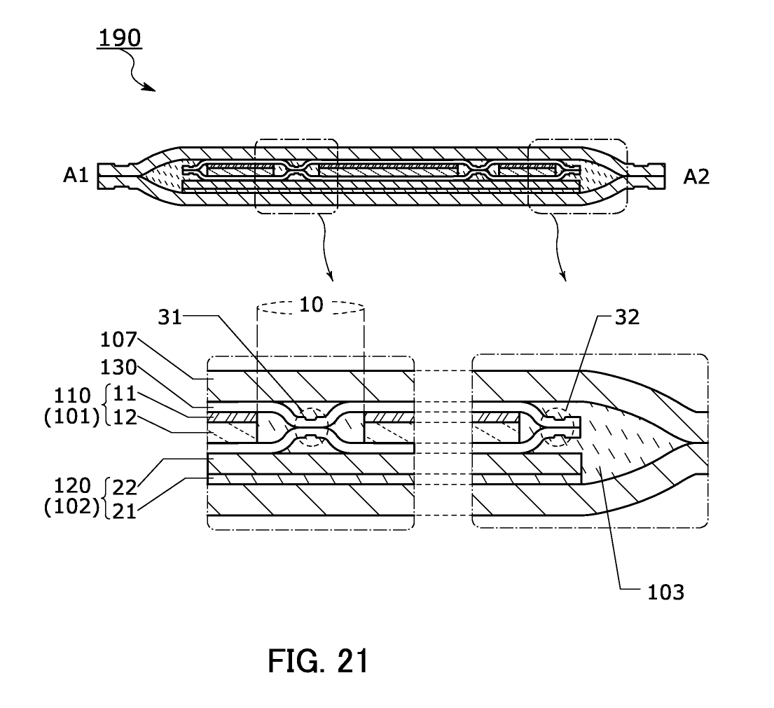

In the example shown in FIG. 1, the openings are provided in both the positive electrode plate and the negative electrode plate. However, in another example of a structure, openings can be provided only in one of the positive electrode plate and the negative electrode plate whereas openings are not provided in the other. FIG. 21 shows an example of such a structure. A power storage unit 190 is different from the power storage unit 100 in that the negative electrode 102 includes a negative electrode plate 120 in which the opening 20 is not formed. Note that in the case where a cross section of the power storage unit 190 is taken along the same line as the section line B1-B2 in FIG. 1, a structure of the cross section of the power storage unit 190 is similar to that shown in FIG. 3.

<<Structural Example 2 of Power Storage Init>>

In Structural example 1, an example in which one electrode plate is included in each of the positive electrode 101 and the negative electrode 102 is described. In a structural example below, an example in which two or more electrode plates are included in each of the positive electrode 101 and the negative electrode 102 is described.

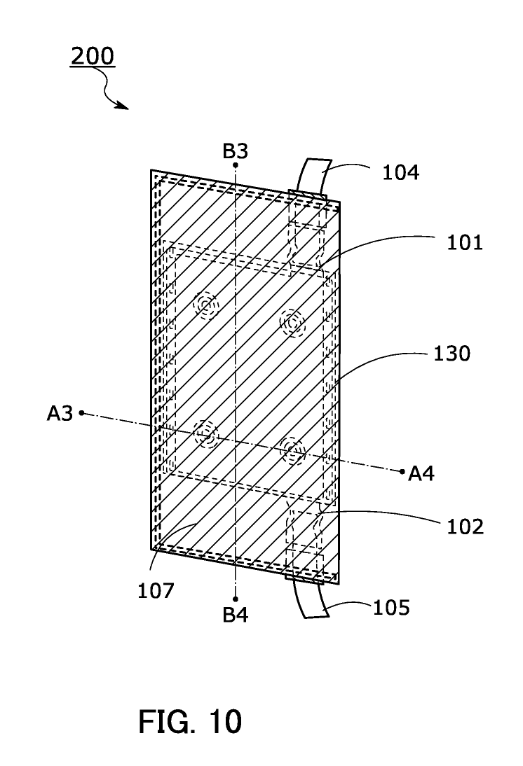

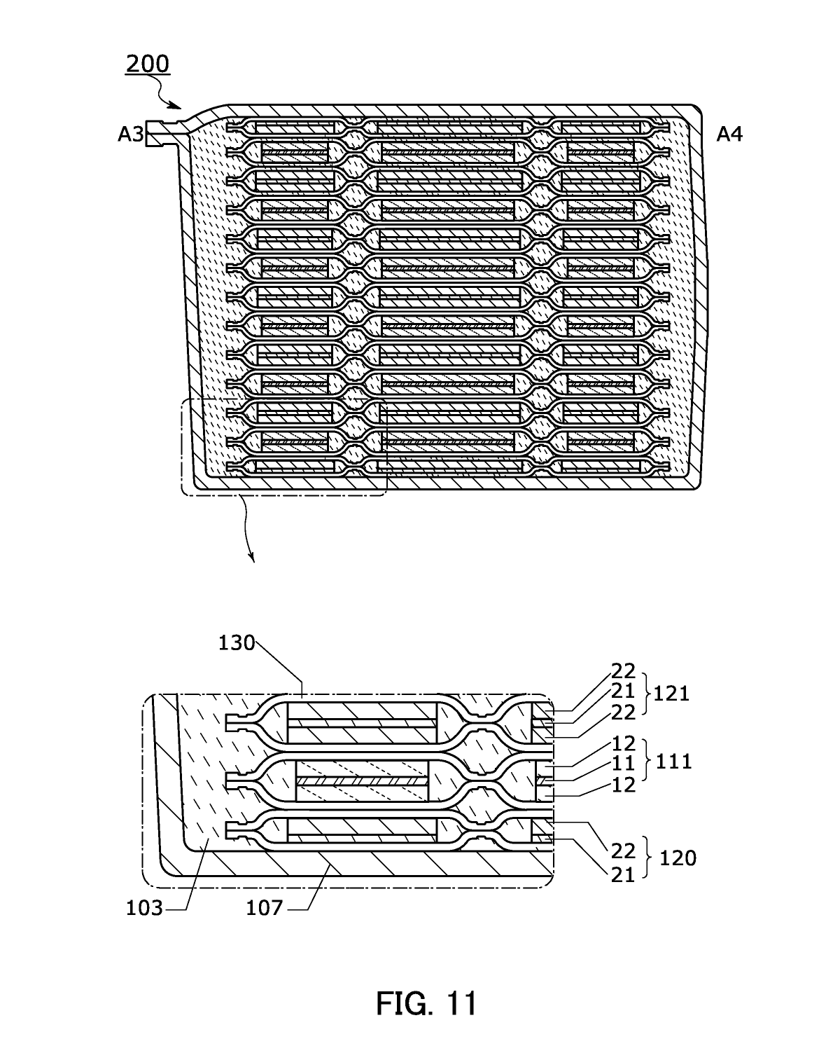

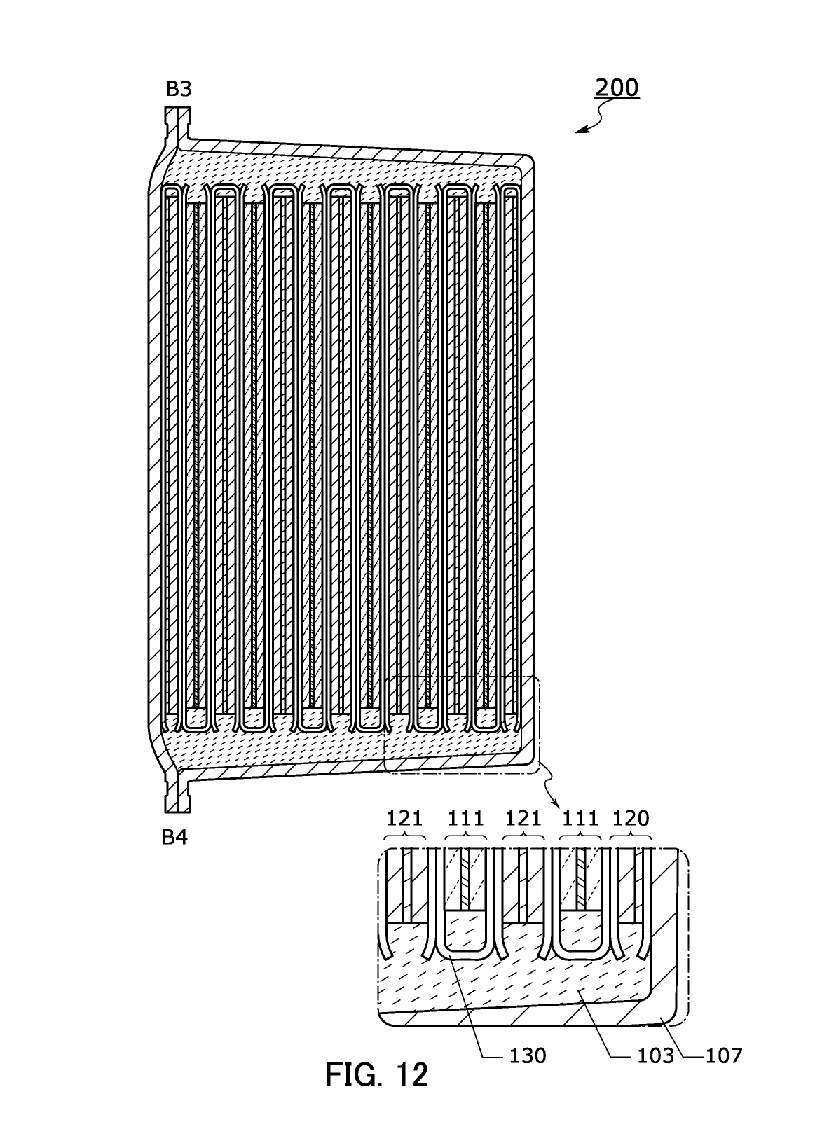

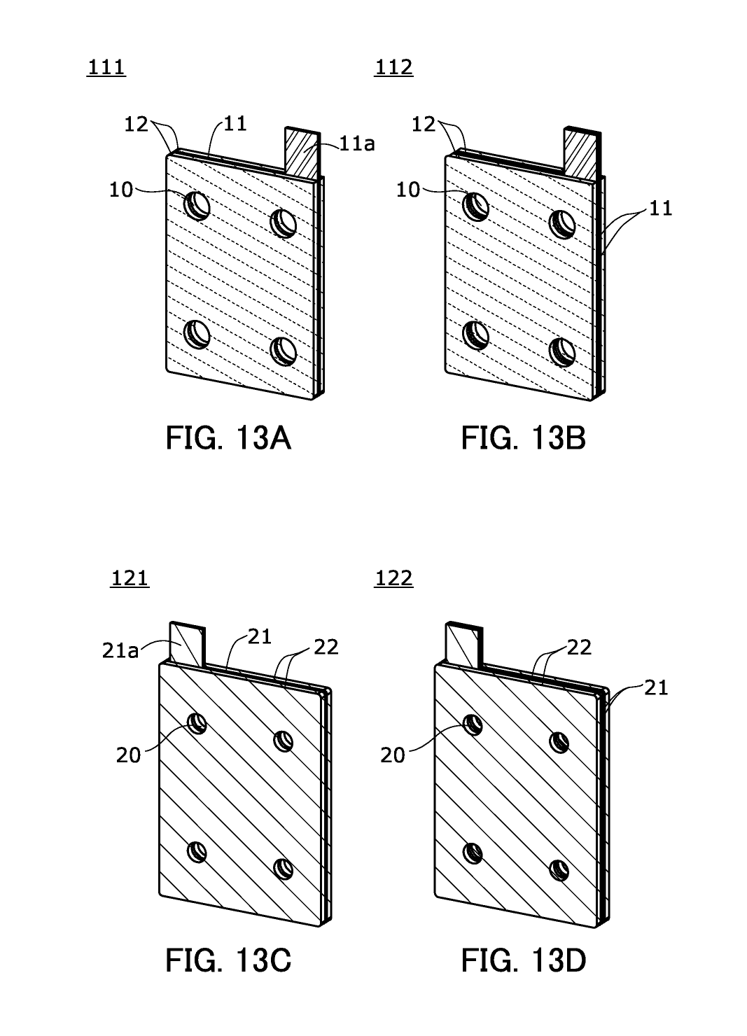

FIG. 10 is an external view showing a structural example of a power storage unit. A cross-sectional view along the section line A3-A4 in FIG. 10 is shown in FIG. 11. A cross-sectional view along the section line B3-B4 in FIG. 10 is shown in FIG. 12. Partially enlarged views are also shown in FIGS. 11 and 12. FIGS. 13A to 13D show structural examples of electrode plates.

Like the power storage unit 100, a power storage unit 200 includes the positive electrode 101, the negative electrode 102, the positive electrode lead 104, the negative electrode lead 105, and the exterior body 107. The positive electrode 101, the negative electrode 102, and the electrolyte solution 103 are sealed in the exterior body 107. The power storage unit 200 is different from the power storage unit 100 in that the positive electrode lead 104 and the negative electrode lead 105 are provided for opposite side surfaces of the exterior body 107.

In the case where two or more positive electrode plates and negative electrode plates each covered by the envelope body are alternated, it is necessary to form an active material layer on both surfaces of the positive electrode plate and the negative electrode plate. FIGS. 13A to 13D show structural examples of such an electrode plate. In the positive electrode plate 111 shown in FIG. 13A, the positive electrode active material layer 12 is formed on both surfaces of one positive electrode current collector 11. In the positive electrode plate 112 shown in FIG. 13B, two positive electrode plates 110 (FIG. 4A) are stacked. The negative electrode plate 121 (FIG. 13C) and the negative electrode plate 122 (FIG. 13D) can be formed in a manner similar to those of the positive electrode plates 111 and 112. In the examples described here, the positive electrode 101 is formed using the positive electrode plate 111, and the negative electrode 102 is formed using the negative electrode plates 120 and 121.

In the examples described here, all of the electrode plates (111, 120, and 121) are fixed to the envelope body 130. Note that different envelope bodies 130 may be used for the positive electrode and the negative electrode. For example, the envelope body 130 made of nonwoven fabric of cellulose or the like is used for the negative electrode in order to remove a deposit, and the envelope body 130 made of a porous resin sheet having a shutdown mechanism is used for the positive electrode. In this way, safety of the power storage unit 200 can be improved.

Furthermore, a large number of electrode plates can be correctly stacked with ease as shown in the drawing by fixing the envelope body to the electrode plates. In the stacked electrode plates (111, 120, and 121), a hole passing through the positive electrode 101 and the negative electrode 102 is formed by the openings (10 and 20). Owing to the hole, the envelope body 130 can be sufficiently impregnated with the electrolyte solution 103, and the step of releasing gas generated in the aging step can be performed easily. Thus, the power storage unit 200 can have high reliability.

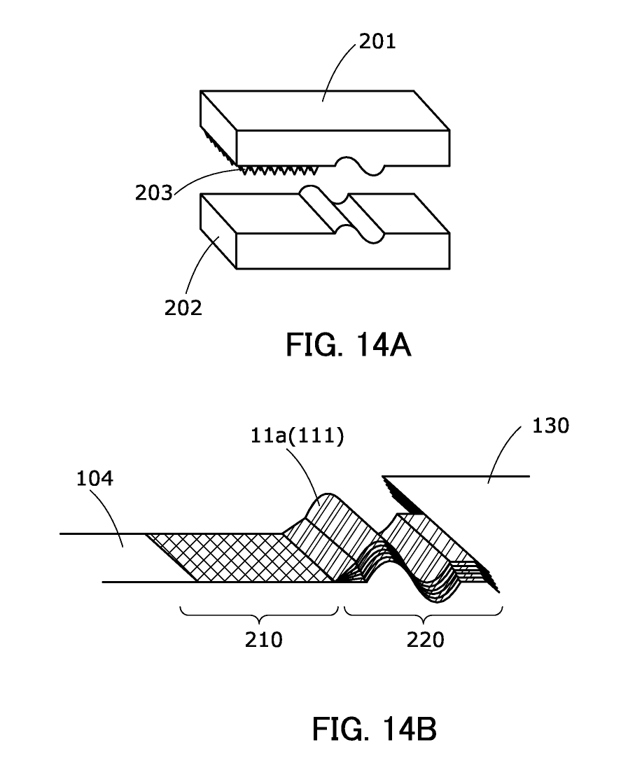

The power storage unit 200 can be manufactured in a manner similar to that of the power storage unit 100. Electrical connection between tabs of the plurality of electrode plates and electrical connection between the tabs and the electrode lead are needed. This step may be performed by ultrasonic welding by which the plurality of electrode plates and the electrode lead can be bonded to each other at a time. The electrode lead is easily cracked or cut by stress applied when the power storage unit is used. Thus, an ultrasonic welding apparatus including bonding dies shown in FIG. 14A is used to bond the plurality of tabs to the electrode lead. Note that only top and bottom bonding dies of the ultrasonic welding apparatus are shown in FIG. 14A for simplicity. Although the bonding of the tab 11a of the positive electrode plate 111 to the positive electrode lead 104 is described here, bonding of the tab 21a of the negative electrode plates 120 and 121 to the negative electrode lead 105 is performed similarly.

The tab 11a and the positive electrode lead 104 are positioned between a bonding die 201 provided with projections 203 and a bonding die 202. At this time, positions of the tab 11a and the positive electrode lead 104 are set so that the projections 203 overlap with a region where the tab 11a and the positive electrode lead 104 are to be connected to each other. Then, ultrasonic welding is performed using the bonding dies 201 and 202. Thus, a connection region 210 and a bent portion 220 can be formed in the positive electrode 101. FIG. 14B is a perspective view in which the connection region 210 and the bent portion 220 of the tab 11a are enlarged. Note that the negative electrode plates (120 and 121) and the envelope body 130 covering them are not shown in FIG. 14B to avoid complexity of the drawing.

This bent portion 82 can relieve stress due to external force applied after manufacture of the power storage unit 200. Thus, the power storage unit 200 can have higher reliability. Although the formation of the bent portion of the electrode tab is performed at the same time as the connection of the tab with the electrode lead in this example, they may be performed separately. The power storage unit 100 may also be manufactured using the ultrasonic welding apparatus shown in FIG. 14A.

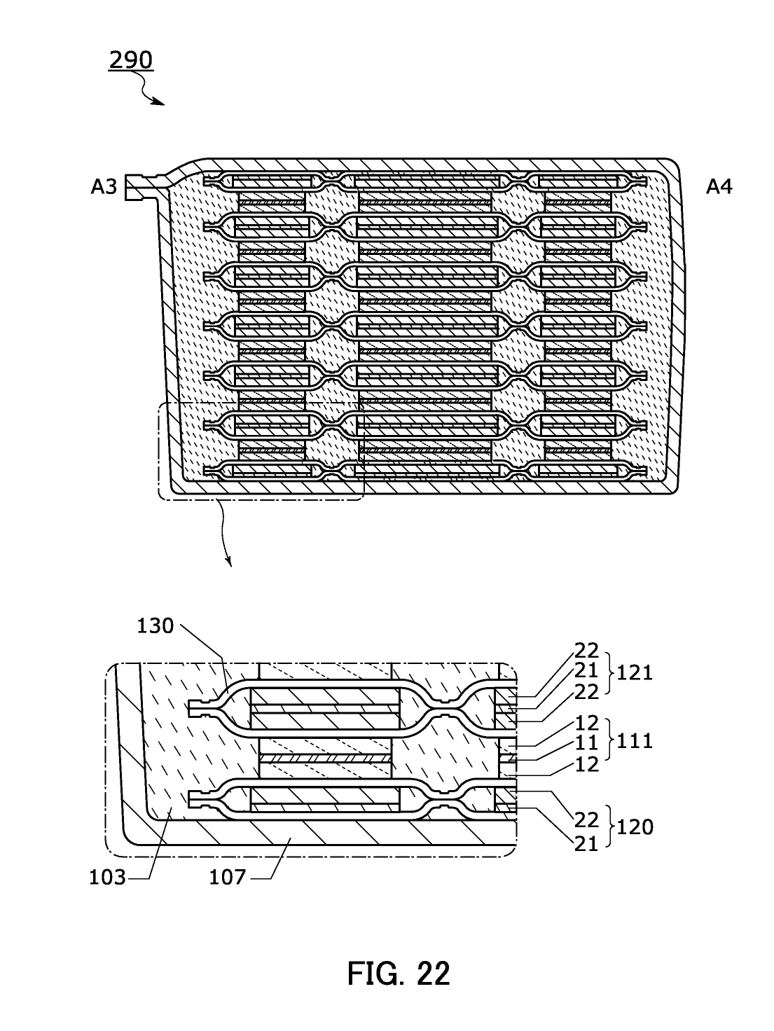

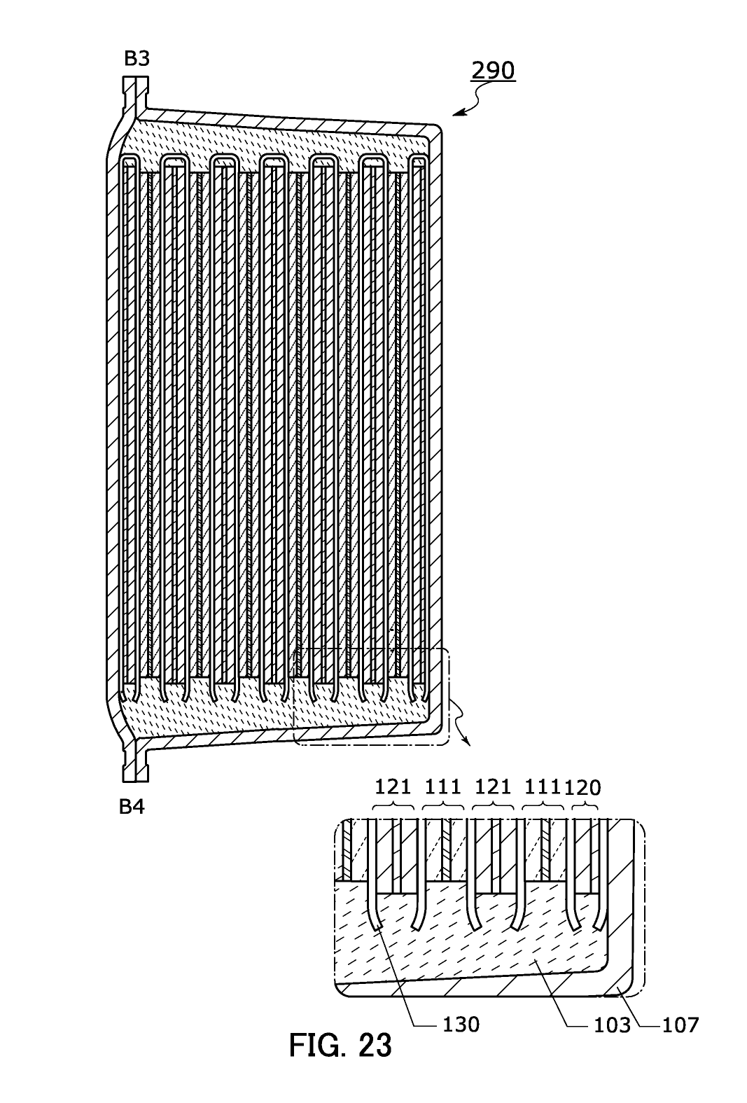

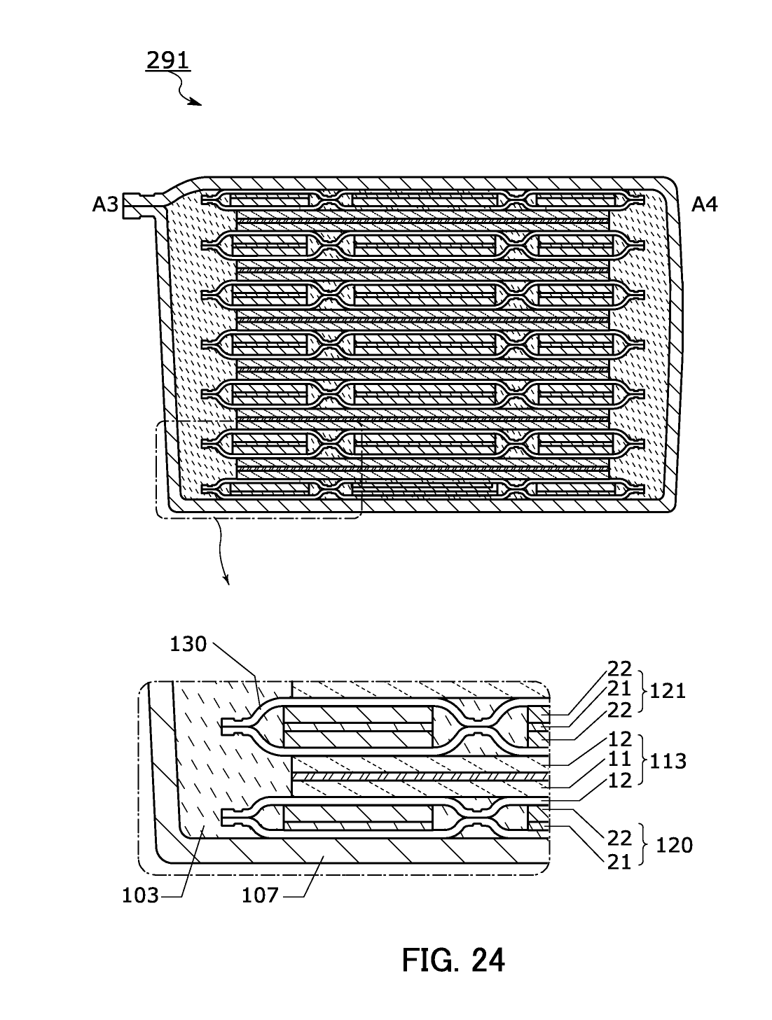

In the structural example of the power storage unit 200 shown in FIG. 10, each of the positive electrode plate and the negative electrode plate is covered by the envelope body. Alternatively, it is possible to use a structure in which one of the positive electrode plate and the negative electrode plate is covered by the envelope body whereas the other thereof is not covered by the envelope body. FIG. 22, FIG. 23, and FIG. 24 show examples of such a structure. A power storage unit 290 shown in FIG. 22 and FIG. 23 is a modification example of the power storage unit 200. The negative electrode plates (120 and 121) are fixed to the envelope bodies 130, whereas the positive electrode plate 111 is not fixed to the envelope body 130. A power storage unit 291 shown in FIG. 24 is a modification example of the power storage unit 290. A positive electrode plate 113 without the opening 10 is used as the positive electrode plate. In the case where a cross section of the power storage unit 291 is taken along the same line as the section line B3-B4 in FIG. 10, a structure of the cross section of the power storage unit 291 is similar to that shown in FIG. 23.

<<Structural Example 3 of Power Storage Unit>>

Other structural examples of the envelope body are described. In the description below, several structural examples of the envelope body 130 covering the positive electrode plate 111 are given.

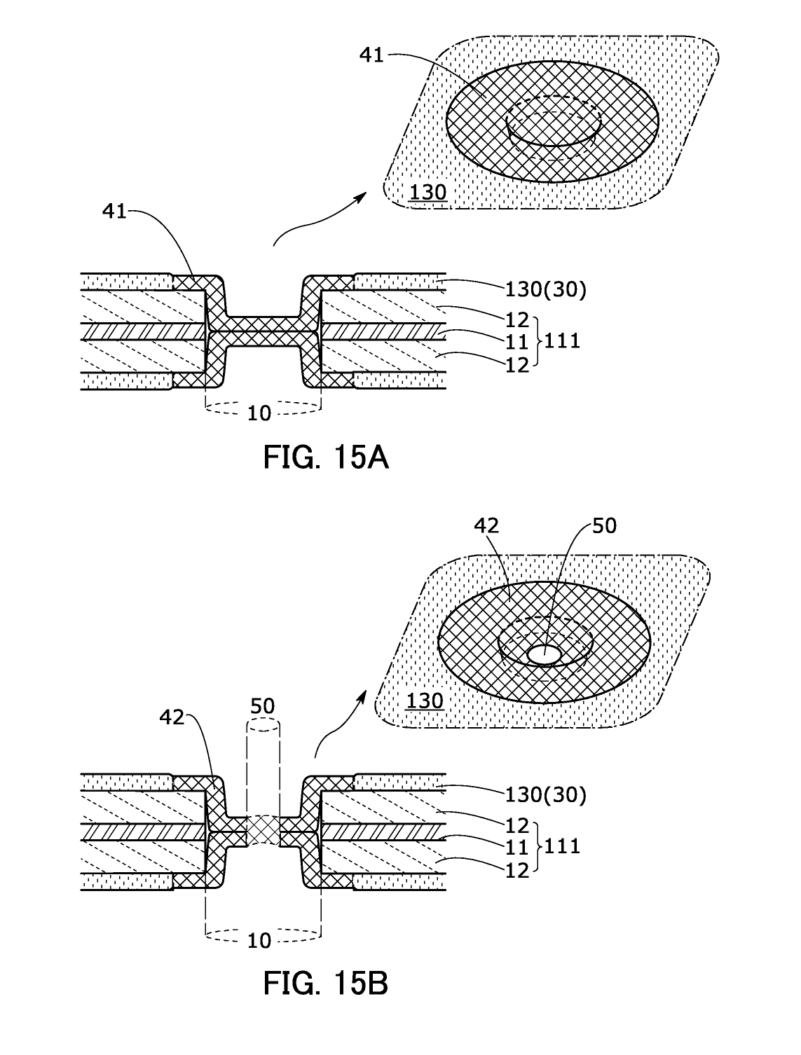

FIGS. 15A and 15B show cross-sectional structures of the envelope body 130 and the positive electrode plate 111 and structures of the envelope body 130 in the vicinity of the opening 10.

In the example shown in FIG. 5D, the bonding portion 31 for fixing the envelope body 130 is formed in the opening 10 of the positive electrode plate 110. A method for forming the bonding portion is not limited thereto. For example, a bonding portion 41 can be formed to fix the envelope body 130 in the opening and in the vicinity of the opening, as shown in FIG. 15A. The bonding portion 41 is formed in a region larger than the opening 10. Thus, in the opening 10, the surfaces of the envelope body 130 (the sheet 30) are bonded to each other, and in a portion outside the opening 10, the envelope body 130 is bonded to a surface of the positive electrode plate 111. The envelope body 130 may also be bonded to a side surface of the positive electrode plate 111.

In the bonding portion 41, a fine hole in the sheet 30 is closed, and therefore, a fluid (the electrolyte solution 103 or gas) is not transferred easily. Then, some methods for fixing the envelope body to the electrode plate by which the electrolyte solution 103 or gas is transferred in the exterior body 107 more smoothly are described below.

For example, a bonding portion 42 is formed to fix the envelope body 130 in the opening and in the vicinity of the opening, as shown in FIG. 15B. The bonding portion 42 is a modification example of the bonding portion 41 and has a structure in which an opening 50 passing through the envelope body 130 is formed in a region of the bonding portion 41 that overlaps with the opening 10. The opening 50 enables the step of injecting the electrolyte solution 103 and the step of releasing gas to be performed easily; thus, a highly reliable power storage unit can be provided. The opening 50 is formed also in the bonding portion 31 in some cases, in a manner similar to that shown in FIG. 15B.

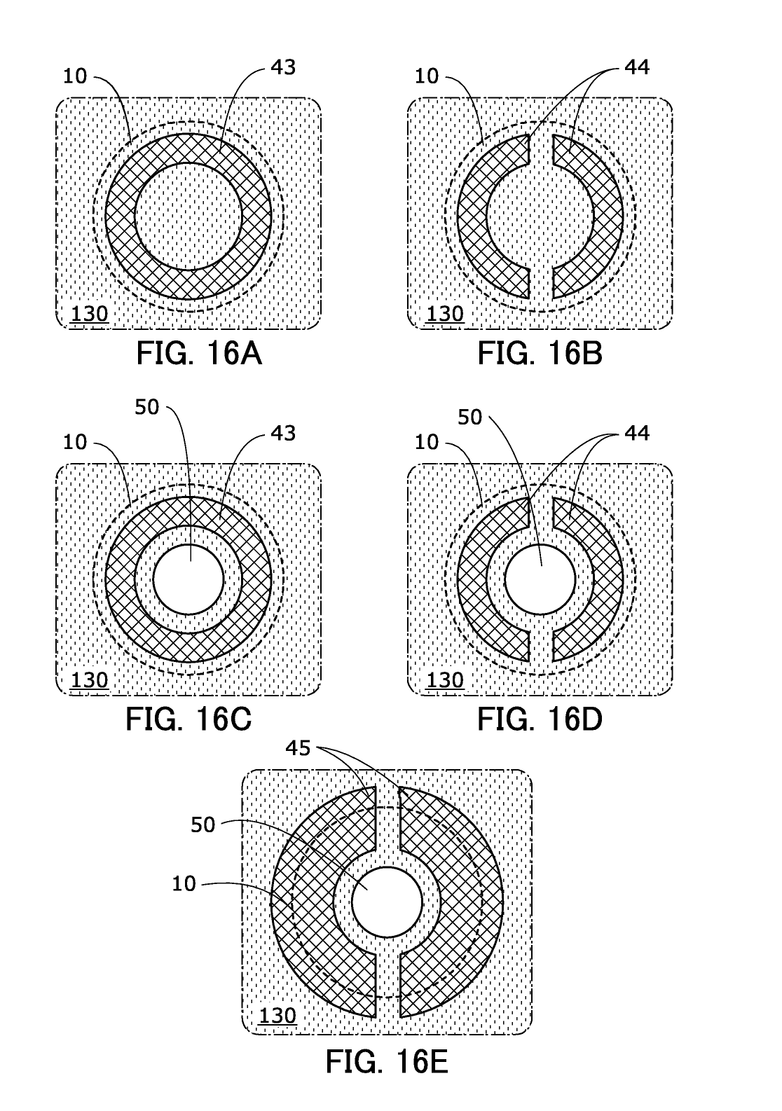

The bonding portion can be formed to fix the envelope body, as shown in FIGS. 16A to 16E. For example, a bonding portion 43 (FIG. 16A) and a bonding portion 44 (FIG. 16B) each have a structure in which surfaces of the envelope body 130 are not bonded to each other in the vicinity of the center of the opening 10. The bonding portion 43 is formed in a ring shape inside the opening 10. The structure of the bonding portion 44 corresponds to a structure where gaps are provided in the bonding portion 43. The opening 50 passing through the envelope body 130 can be formed in a region surrounded by the bonding portion 43 or the bonding portion 44 (FIGS. 16C and 16D).

Also in the examples shown in FIGS. 16A to 16D, the surface of the positive electrode plate 111 can be fixed to the envelope body 130 outside the opening 10 in a manner similar to that of the bonding portion 42 (FIG. 15B). For example, a bonding portion 45 may be formed as shown in FIG. 16E. FIG. 16E is a modification example of FIG. 16D. The structures shown in FIGS. 16A to 16C can be similarly modified.

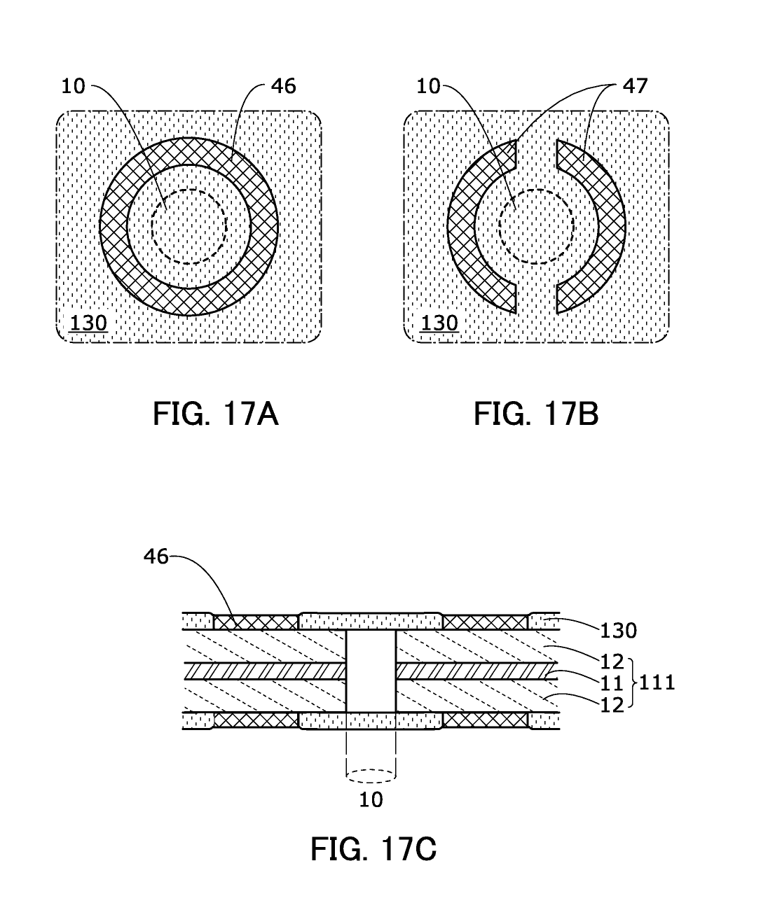

The bonding portion can be formed to fix the envelope body in a region that does not overlap with the opening of the electrode plate. FIGS. 17A to 17C show examples of such a structure. A bonding portion 46 is formed in a ring shape so as to surround a region outside the opening 10. As shown in FIG. 17C, the envelope body 130 is fixed to a surface of the positive electrode plate 111 in the bonding portion 46. A portion where the envelope bodies 130 are fixed is not present in the opening 10. Alternatively, a bonding portion 47 as shown in FIG. 17B can be formed. The structure of the bonding portion 47 corresponds to a structure in which gaps are provided in the bonding portion 46. A cross-sectional structure of the envelope body 130 fixed by the bonding portion 47 is shown in FIG. 17C.

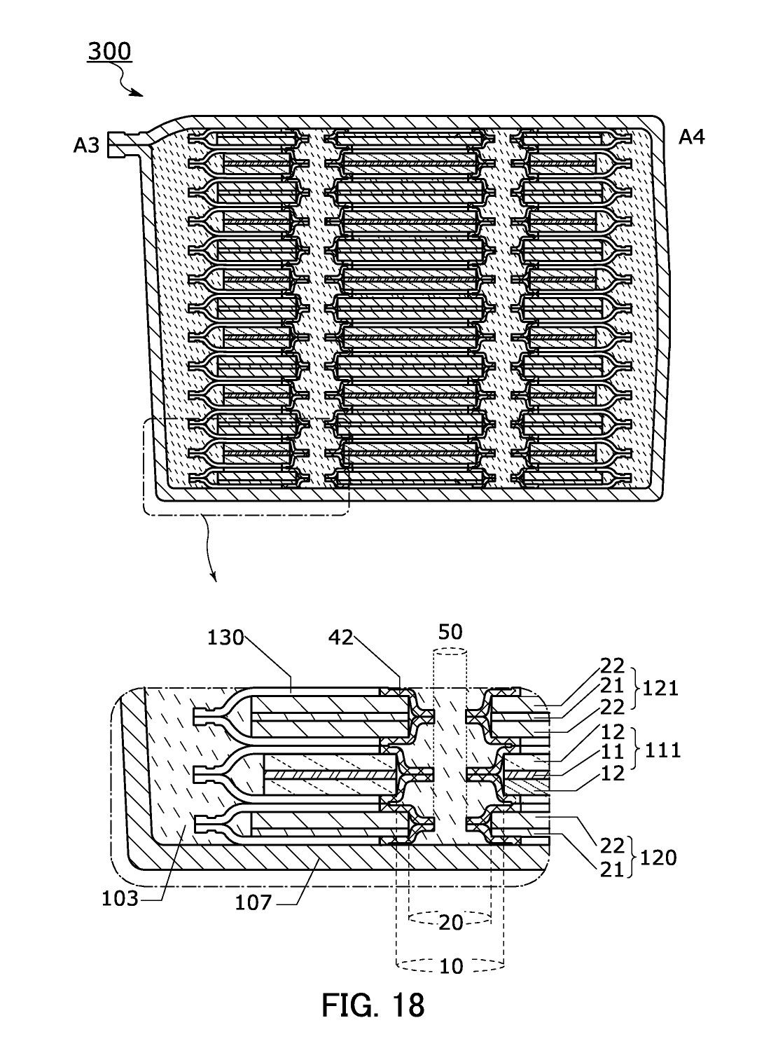

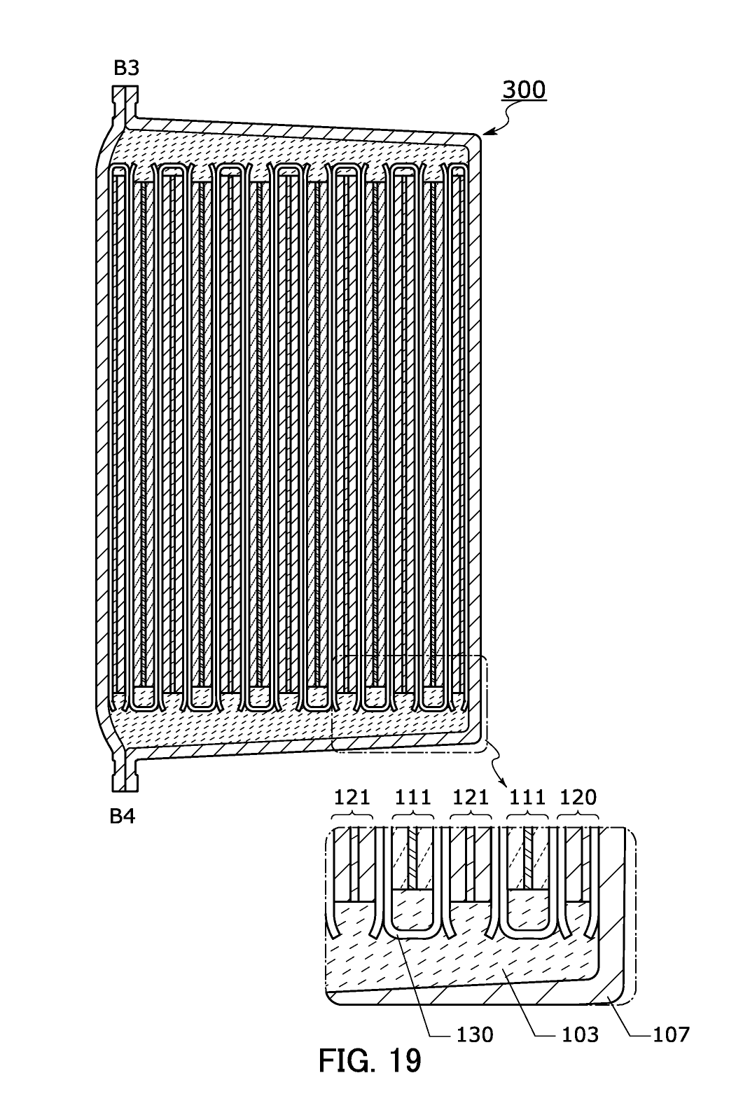

FIGS. 18 and 19 are cross-sectional views showing structural examples of a power storage unit. An external view of the power storage unit 300 is similar to that of the power storage unit 200 (FIG. 10). In the power storage unit 300, the envelope body and the electrode plate are fixed to each other using the structural example shown in FIG. 15B. As shown in FIG. 18, the opening 50 is formed in the envelope bodies 130 so as to overlap with the openings (10 and 20) of the electrode plates (111, 120, and 121). Such a structure enables the step of injecting the electrolyte solution 103 and the step of releasing gas to be performed more easily than the case of the power storage unit 200.

<<Structural Example 4 of Power Storage Unit>>

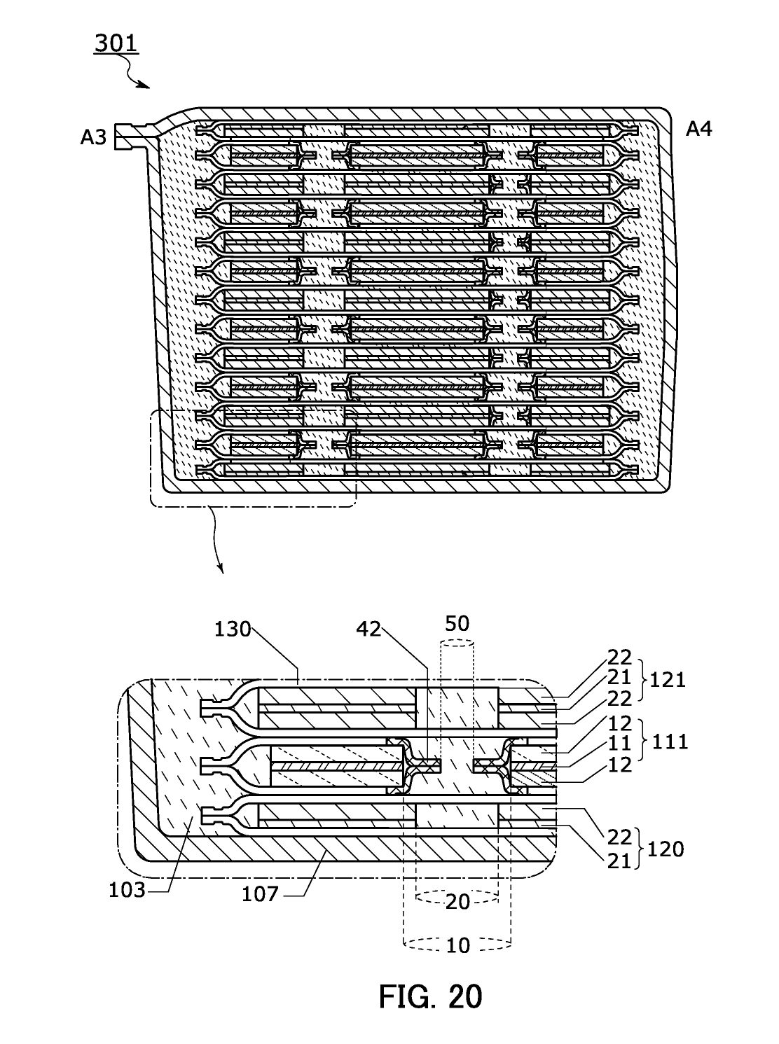

The bonding portion for fixing the envelope body is not necessarily formed in the opening of one of the positive electrode plate and the negative electrode plate. FIG. 20 shows an example of such a structure. A power storage unit 301 shown in FIG. 20 can be regarded as a modification example of the power storage unit 300. In the power storage unit 301, the bonding portion 42 for fixing the envelope body 130 that covers the negative electrode plates (120 and 121) is not formed.

<<Structural Example 5 of Power Storage Unit>>

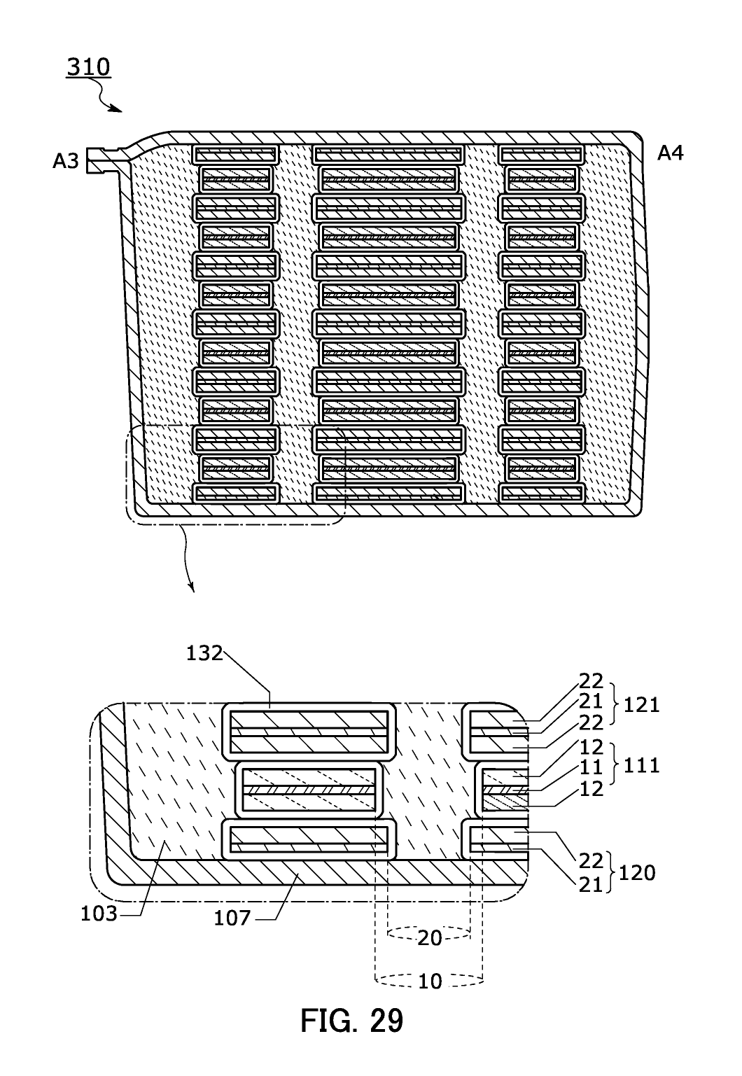

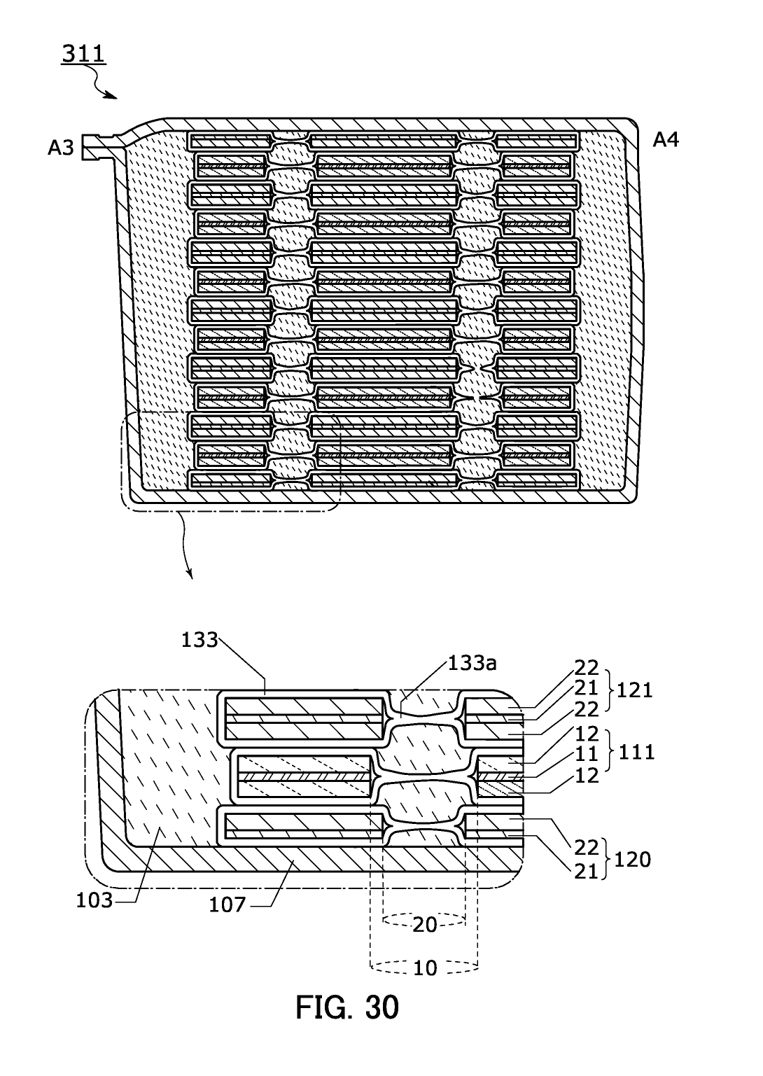

In the above-mentioned structural examples, the envelope body is formed using a sheet of an insulator. A method for forming the envelope body is not limited thereto. For example, the envelope body can be formed by coating, dip coating, spin coating, an electrophoresis method, an evaporation method, a cast method, or the like. In particular, dip coating is preferably used. FIGS. 29 and 30 show structural examples of a power storage unit including an envelope body formed by dip coating. A power storage unit 310 shown in FIG. 29 and a power storage unit 311 shown in FIG. 30 are modification examples of the power storage unit 300 shown in FIG. 18.

By the above-described method, the electrode plate including the opening and the envelope body can be integrated. As shown in FIG. 29, an envelope body 132 is formed of an insulator that covers a top surface, a bottom surface, and side surfaces of the electrode plate (111, 121, or 120) and a side surface of the opening (10 or 20) and is in close contact with the electrode plate (111, 121, or 120). In the case where polymer is used for the envelope body 132, the following method can be employed: a method in which dip coating is performed using a solvent in which a polymer to be the envelope body 132 is dissolved; a method in which, after dip coating is performed using a polymer or a polymer precursor to be the envelope body 132, cross-linking is performed to form the envelope body 132; or the like.

The envelope body 132 is preferably porous. For example, the envelope body 132 may be formed of a porous film in the following manner. After a polymer or a polymer precursor to be the envelope body 132 and an additive are dispersed in a solution for dip coating, the electrode plate (111, 121, or 120) including the opening (10 or 20) is dipped in and coated with the resulting dispersion liquid, and then, the additive is removed. For example, in the case where the polymer or the polymer precursor is made to undergo cross-linking, the additive may be removed after the cross-linking

The envelope body 132 may be formed using fiber such as glass fiber. For example, the envelope body 132 is formed through dip coating on the electrode plate (111, 121, or 120) including the opening (10 or 20) with use of a dispersion liquid in which fiber is dispersed in a solvent.

In the case where the envelope body is formed by dip coating or the like, a film of an insulator forming the envelope body may be formed in the opening of the electrode plate. FIG. 30 shows an example of such a structure. An envelope body 133 shown in FIG. 30 includes a film 133a of an insulator in the openings (10 and 20). The film 133a is not necessarily continuous in the openings (10 and 20). In other words, the envelope body 132 may include a portion (the film 133a) that wholly or partly covers the opening (10 or 20).

The envelope body with high coverage can be formed by dip coating or the like. In the case of using the dip coating, a film thickness can be easily adjusted by controlling the concentration of a solution. The envelope body has a function of preventing a short circuit between the positive electrode and the negative electrode. Because the envelope body formed by the above-mentioned method has high coverage, the thickness of the envelope body can be reduced to a minimum necessary for preventing a short circuit. Reducing the thickness of the envelope body can decrease the distance between the positive electrode and the negative electrode and accordingly reduce the electrical resistance between the positive electrode and the negative electrode, which leads to a further increase in charge and discharge rate.

<<Structural Example 6 of Power Storage Unit>>

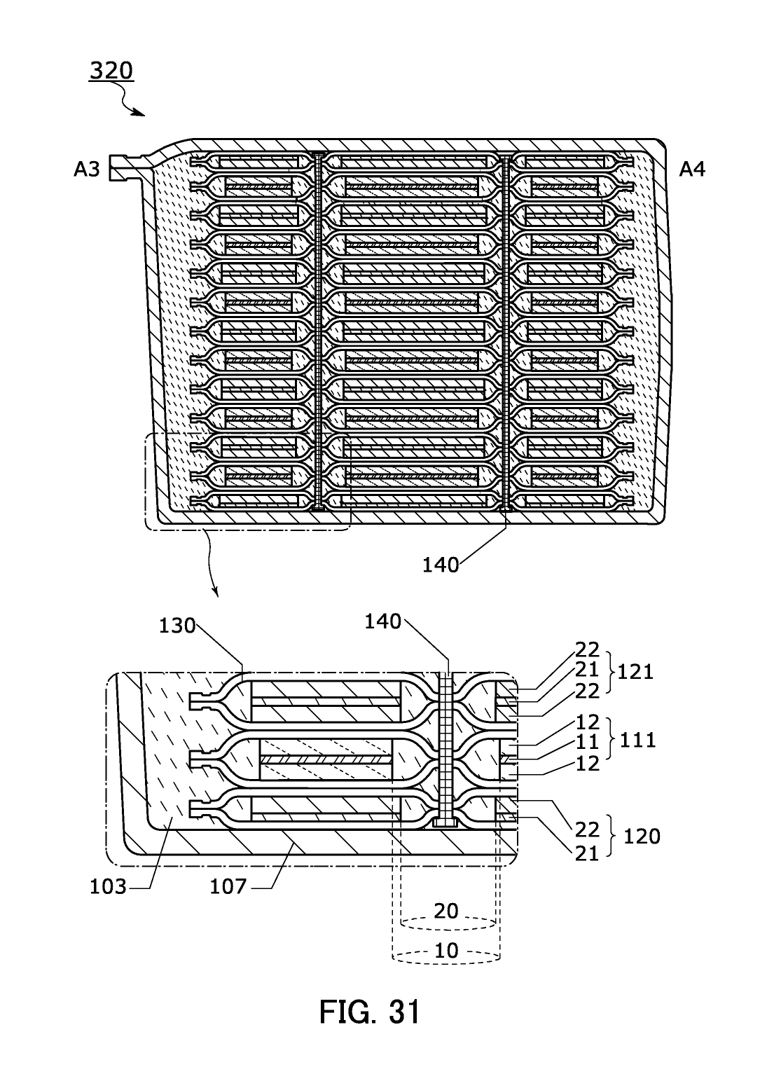

A power storage unit 320 shown in FIG. 31 is a modification example of the power storage unit 200 (FIG. 11). As described above, in the stacked electrode plates (111, 120, and 121), a hole passing through the positive electrode 101 and the negative electrode 102 is formed by the openings (10 and 20). In the power storage unit 320, the hole is used to fix the electrode plates, and a fixing member 140 is provided in the hole. For example, after the electrode plates (111, 120, and 121) are stacked, a pin-like fixing member 140 with rigidity penetrates through the envelope bodies 130, so that the fixing member 140 can be placed. The fixing member 140 may be formed using an insulator such as resin.

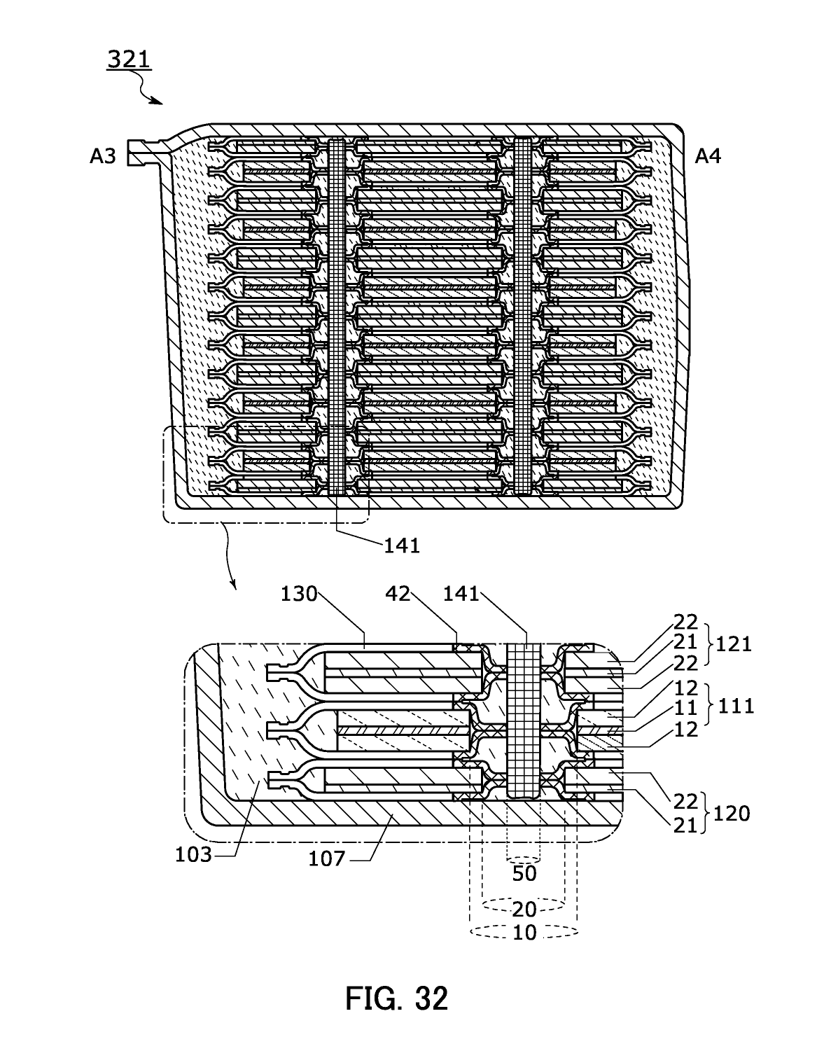

A power storage unit 321 shown in FIG. 32 is a modification example of the power storage unit 300 (FIG. 18). In the case where the openings 50 are formed in the envelope bodies 130 as in the power storage unit 300 (FIG. 18), after the electrode plates (111, 120, and 121) are stacked, a through hole formed by the opening 50 is filled with a resin material and curing is performed, whereby a fixing member 141 can be formed. Note that the fixing member 140 shown in FIG. 31 can be provided in the power storage unit 300 or the like.

The fixing member 140 or 141 may be provided in all of the through holes in the power storage unit, or may be provided in part of the through holes in the power storage unit.

In this embodiment, what is called a laminated battery using an exterior body formed using a film is described as the power storage unit. Alternatively, the electrode plate fixed to the envelope body can be used for a power storage unit having another structure, e.g., a coin-type battery or a wound battery.

### Embodiment 2

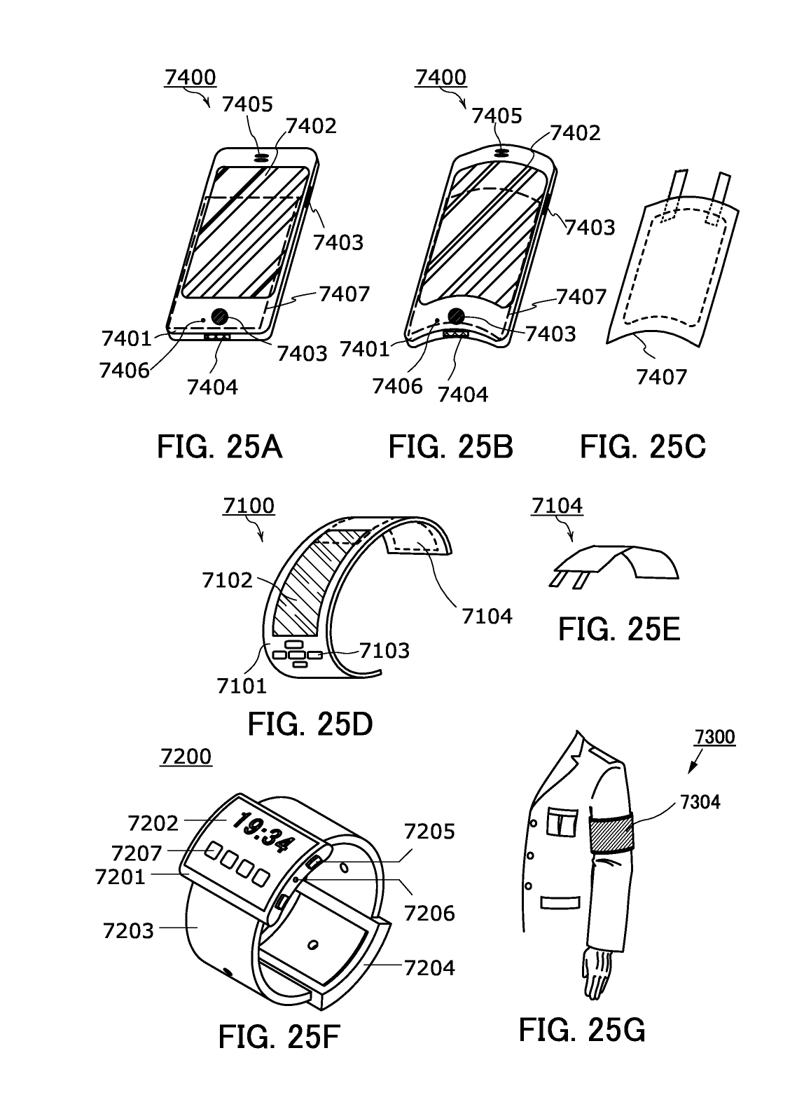

The power storage unit of one embodiment of the present invention can be used as a power supply of various electronic devices which are driven by electric power. FIGS. 25A to 25G, FIGS. 26A to 26C, FIG. 27, and FIGS. 28A and 28B illustrate specific examples of the electronic devices using a power storage unit of one embodiment of the present invention.

Specific examples of the electronic devices using the power storage unit of one embodiment of the present invention are as follows: display devices of televisions, monitors, and the like, lighting devices, desktop and laptop personal computers, word processors, image reproduction devices which reproduce still images and moving images stored in recording media such as digital versatile discs (DVDs), portable CD players, radios, tape recorders, headphone stereos, stereos, table clocks, wall clocks, cordless phone handsets, transceivers, mobile phones, car phones, portable game machines, tablet terminals, large game machines such as pachinko machines, calculators, portable information terminals, electronic notebooks, e-book readers, electronic translators, audio input devices, video cameras, digital still cameras, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electrical tools such as a chain saw, smoke detectors, and medical equipment such as dialyzers. Other examples are as follows: industrial equipment such as guide lights, traffic lights, conveyor belts, elevators, escalators, industrial robots, power storage systems, and power storage devices for leveling the amount of power supply and smart grid. In addition, moving objects and the like driven by electric motors using power from a power storage device are also included in the category of electronic devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In addition, the power storage unit of one embodiment of the present invention can be incorporated along a curved inside/outside wall surface of a house or a building or a curved interior/exterior surface of a car.

FIG. 25A illustrates an example of a mobile phone. A mobile phone 7400 includes a display portion 7402 incorporated in a housing 7401, an operation button 7403, an external connection port 7404, a speaker 7405, a microphone 7406, and the like. Note that the mobile phone 7400 includes a power storage unit 7407.

The mobile phone 7400 illustrated in FIG. 25B is bent. When the whole mobile phone 7400 is bent by the external force, the power storage unit 7407 included in the mobile phone 7400 is also bent. FIG. 25C illustrates the bent power storage unit 7407.

FIG. 25D illustrates an example of a bangle display device. A portable display device 7100 includes a housing 7101, a display portion 7102, an operation button 7103, and a power storage unit 7104. FIG. 25E illustrates the bent power storage unit 7104.

FIG. 25F illustrates an example of a wrist-watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is bent, and images can be displayed on the bent display surface. Further, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as power ON/OFF, ON/OFF of wireless communication, setting and cancellation of manner mode, and setting and cancellation of power saving mode can be performed. For example, the functions of the operation button 7205 can be set freely by setting the operation system incorporated in the portable information terminal 7200.

Further, the portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. Power charging through the input output terminal 7206 is possible. Note that the charging operation may be performed by wireless power feeding without using the input output terminal 7206.

The portable information terminal 7200 includes the power storage unit of one embodiment of the present invention. For example, the power storage unit 7104 shown in FIG. 25E can be incorporated in the housing 7201 with a state where the power storage unit 7104 is bent or can be incorporated in the band 7203 with a state where the power storage unit 7104 can be bent.

FIG. 25G illustrates an example of an armband display device. A display device 7300 includes a display portion 7304 and the power storage unit of one embodiment of the present invention. The display device 7300 can include a touch sensor in the display portion 7304 and can serve as a portable information terminal.

The display surface of the display portion 7304 is bent, and images can be displayed on the bent display surface. A display state of the display device 7300 can be changed by, for example, near field communication that is a communication method based on an existing communication standard.

The display device 7300 includes an input output terminal, and data can be directly transmitted to and received from another information terminal via a connector.

Power charging through the input output terminal is possible. Note that the charging operation may be performed by wireless power feeding without using the input output terminal.

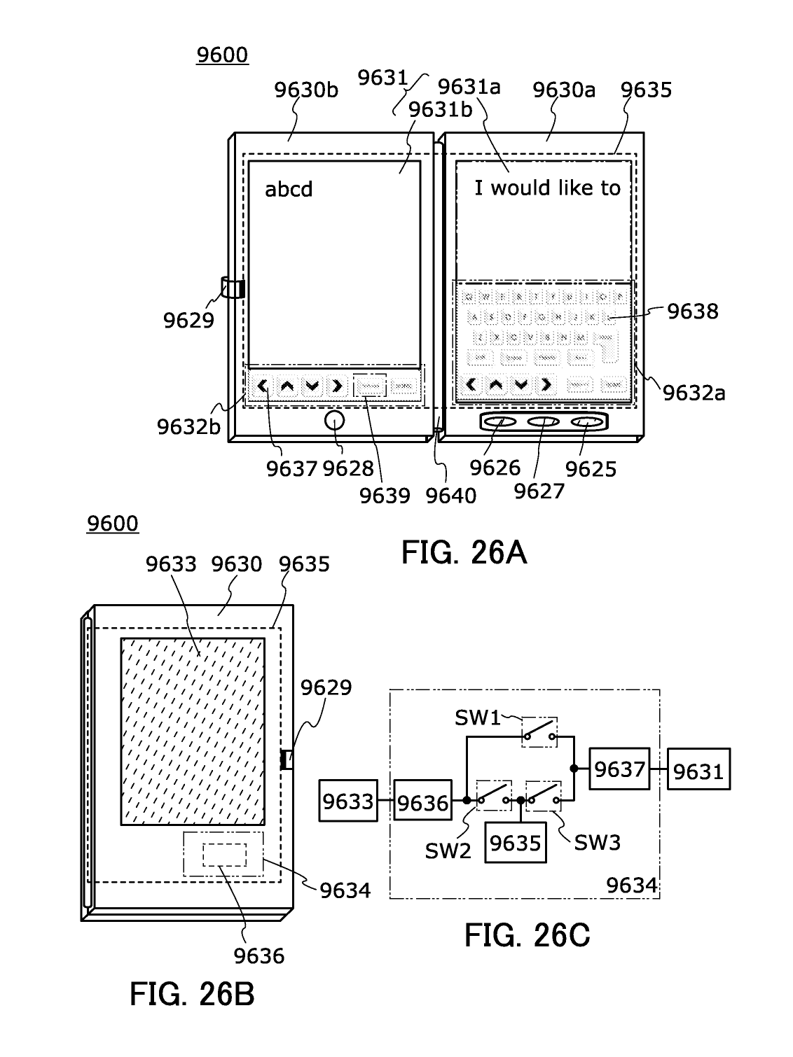

FIGS. 26A and 26B illustrate an example of a foldable tablet terminal. A tablet terminal 9600 illustrated in FIGS. 26A and 26B includes a housing 9630 provided with a housing 9630a and a housing 9630b, a movable portion 9640 connecting the housings 9630a and 9630b, a display portion 9631 provided with a display portion 9631a and a display portion 9631b, a display mode switch 9626, a power switch 9627, a power saver switch 9625, a fastener 9629, and an operation switch 9628. FIGS. 26A and 26B illustrate the tablet terminal 9600 opened and closed, respectively.

The tablet terminal 9600 includes a power storage unit 9635 inside the housings 9630a and 9630b. The power storage unit 9635 is provided across the housings 9630a and 9630b, passing through the movable portion 9640.

Part of the display portion 9631 a can be a touch panel region 9632a and data can be input when a displayed operation key 9638 is touched. FIG. 26A shows, but is not limited to, a structure in which a half region in the display portion 9631a has only a display function and the other half region has a touch panel function. The whole area of the display portion 9631a may have a touch panel function. For example, the whole area of the display portion 9631a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode switch 9626 can switch the display between portrait mode, landscape mode, and the like, and between monochrome display and color display, for example. The power saver switch 9625 can control display luminance in accordance with the amount of external light in use of the tablet terminal 9600, which is measured with an optical sensor incorporated in the tablet terminal 9600. The tablet terminal may include another detection device such as a gyroscope or an acceleration sensor in addition to the optical sensor.

Although FIG. 26A illustrates an example in which the display portions 9631a and 9631b have the same display area, the display portions 9631a and 9631b may have different display areas and different display quality. For example, higher-resolution images may be displayed on one of the display portions 9631a and 9631b.

The tablet terminal is closed in FIG. 26B. The tablet terminal includes the housing 9630, a solar cell 9633, and a charge and discharge control circuit 9634 including a DC-DC converter 9636. The power storage unit of one embodiment of the present invention is used as the power storage unit 9635.

The tablet terminal 9600 can be folded in two so that the housings 9630a and 9630b overlap with each other when not in use. Thus, the display portions 9631a and 9631b can be protected, which increases the durability of the tablet terminal 9600. In addition, the power storage unit 9635 of one embodiment of the present invention has flexibility and can be repeatedly bent without a large decrease in charge and discharge capacity. Thus, a highly reliable tablet terminal can be provided.

The tablet terminal illustrated in FIGS. 26A and 26B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 in FIG. 26B are described with reference to a block diagram in FIG. 26C. The solar cell 9633, the power storage unit 9635, the DC-DC converter 9636, a converter 9637, switches SW1, SW2, and SW3, and the display portion 9631 are illustrated in FIG. 26C, and the power storage unit 9635, the DC-DC converter 9636, the converter 9637, and the switches SW1, SW2, and SW3 correspond to the charge and discharge control circuit 9634 in FIG. 26B.

First, an example of the operation in the case where electric power is generated by the solar cell 9633 using external light is described. The voltage of electric power generated by the solar cell is raised or lowered by the DC-DC converter 9636 to a voltage for charging the power storage unit 9635. Then, when the electric power from the solar cell 9633 is used for the operation of the display portion 9631, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation means; however, one embodiment of the present invention is not limited to this example. The power storage unit 9635 may be charged using another power generation means such as a piezoelectric element or a thermoelectric conversion element (Peltier element). For example, the power storage unit 9635 may be charged using a non-contact power transmission module that transmits and receives electric power wirelessly (without contact) or using another charging means in combination.

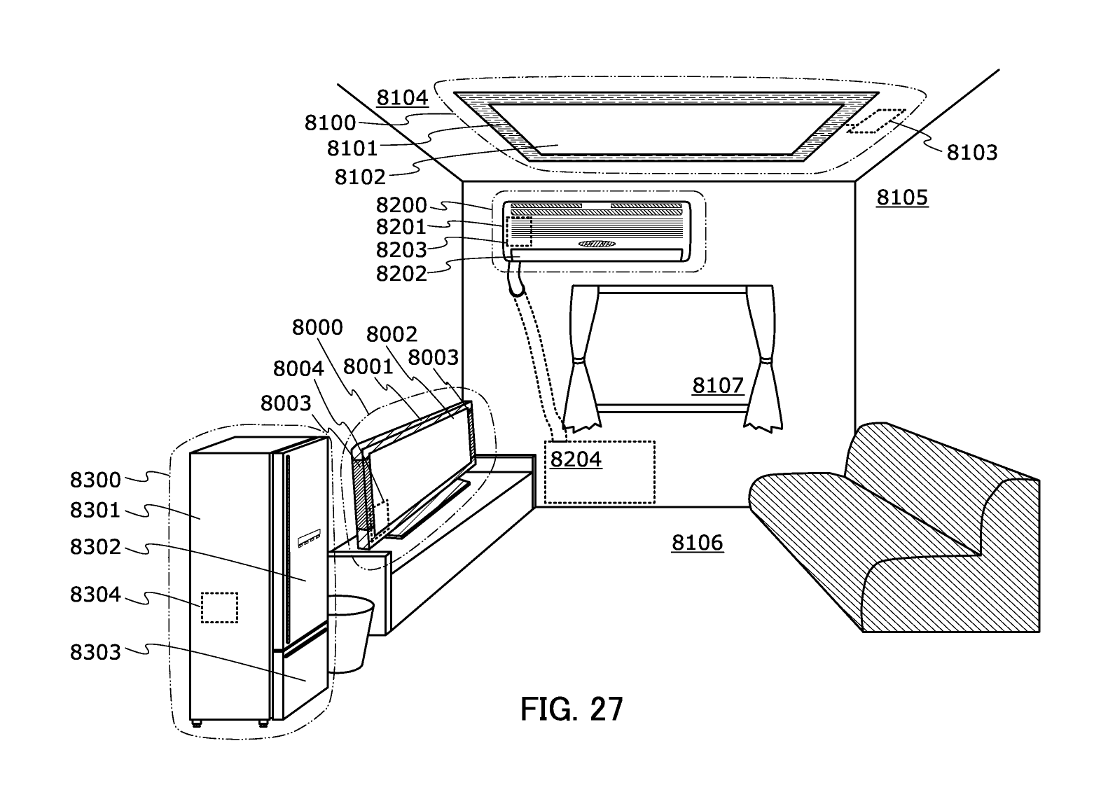

FIG. 27 illustrates examples of other electronic devices. In FIG. 27, a display device 8000 is an example of an electronic device including the power storage unit of one embodiment of the present invention. Specifically, the display device 8000 corresponds to a display device for TV broadcast reception and includes a housing 8001, a display portion 8002, speaker portions 8003, a power storage device 8004, and the like. The power storage device 8004 includes the power storage unit of one embodiment of the present invention and is provided in the housing 8001. The display device 8000 can receive electric power from a commercial power source or use electric power stored in the power storage device 8004. Thus, the display device 8000 can operate with the use of the power storage device 8004 of one embodiment of the present invention as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all information display devices for personal computers, advertisement displays, and the like besides the ones for TV broadcast reception.

In FIG. 27, an installation lighting device 8100 is an example of an electronic device including the power storage unit of one embodiment of the present invention. Specifically, the lighting device 8100 includes a housing 8101, a light source 8102, a power storage device 8103, and the like. The power storage device 8103 includes the power storage unit of one embodiment of the present invention. Although FIG. 27 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power source or use electric power stored in the power storage device 8103. Thus, the lighting device 8100 can operate with the use of the power storage device 8103 of one embodiment of the present invention as an uninterruptible power source even when electric power cannot be supplied from a commercial power source because of power failure or the like.

Although the installation lighting device 8100 provided in the ceiling 8104 is illustrated in FIG. 27 as an example, the power storage device including the power storage unit of one embodiment of the present invention can be used in an installation lighting device provided in, for example, a wall 8105, a floor 8106, a window 8107, or the like besides the ceiling 8104. Alternatively, the power storage device can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 27, an air conditioner including an indoor unit 8200 and an outdoor unit 8204 is an example of an electronic device including the power storage unit of one embodiment of the present invention. Specifically, the indoor unit 8200 includes a housing 8201, an air outlet 8202, the power storage device 8203, and the like. The power storage device 8203 includes the power storage unit of one embodiment of the present invention. Although FIG. 27 illustrates the case where the power storage device 8203 is provided in the indoor unit 8200, the power storage device 8203 may be provided in the outdoor unit 8204. Alternatively, the power storage device 8203 may be provided in both the indoor unit 8200 and the outdoor unit 8204. The air conditioner can receive electric power from a commercial power source or use electric power stored in the power storage device 8203. Particularly in the case where the power storage device 8203 is provided in both the indoor unit 8200 and the outdoor unit 8204, the air conditioner can operate with the use of the power storage device 8203 of one embodiment of the present invention as an uninterruptible power source even when electric power cannot be supplied from a commercial power source because of power failure or the like.

Note that although the split-type air conditioner including the indoor unit and the outdoor unit is illustrated in FIG. 27 as an example, a power storage device including the power storage unit of one embodiment of the present invention can be used in an air conditioner in which the functions of an indoor unit and an outdoor unit are integrated in one housing.

In FIG. 27, an electric refrigerator-freezer 8300 is an example of an electronic device including the power storage unit of one embodiment of the present invention. Specifically, the electric refrigerator-freezer 8300 includes a housing 8301, a door for a refrigerator 8302, a door for a freezer 8303, a power storage device 8304, and the like.

The power storage device 8304 includes the power storage unit of one embodiment of the present invention. In FIG. 27, the power storage device 8304 is provided in the housing 8301. The electric refrigerator-freezer 8300 can receive electric power from a commercial power source or use electric power stored in the power storage device 8304. Thus, the electric refrigerator-freezer 8300 can operate with the use of the power storage device 8304 including the power storage unit of one embodiment of the present invention as an uninterruptible power source even when electric power cannot be supplied from a commercial power source because of power failure or the like.

Note that among the electronic devices described above, the high-frequency heating appliances such as microwave ovens, the electric rice cookers, and the like require high electric power in a short time. The tripping of a circuit breaker of a commercial power source in use of the electronic devices can be prevented by using a power storage device including the power storage unit of one embodiment of the present invention as an auxiliary power source for making up for the shortfall in electric power supplied from a commercial power source.

In addition, in a time period when electronic devices are not used, specifically when the proportion of the amount of electric power which is actually used to the total amount of electric power which can be supplied from a commercial power source (such a proportion is referred to as power usage rate) is low, electric power can be stored in the power storage device, whereby the power usage rate can be reduced in a time period when the electronic devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power source; thus, the power usage rate in daytime can be reduced.

The use of a power storage device in vehicles can lead to next-generation clean energy vehicles such as hybrid electric vehicles (HEVs), electric vehicles (EVs), and plug-in hybrid electric vehicles (PHEVs).

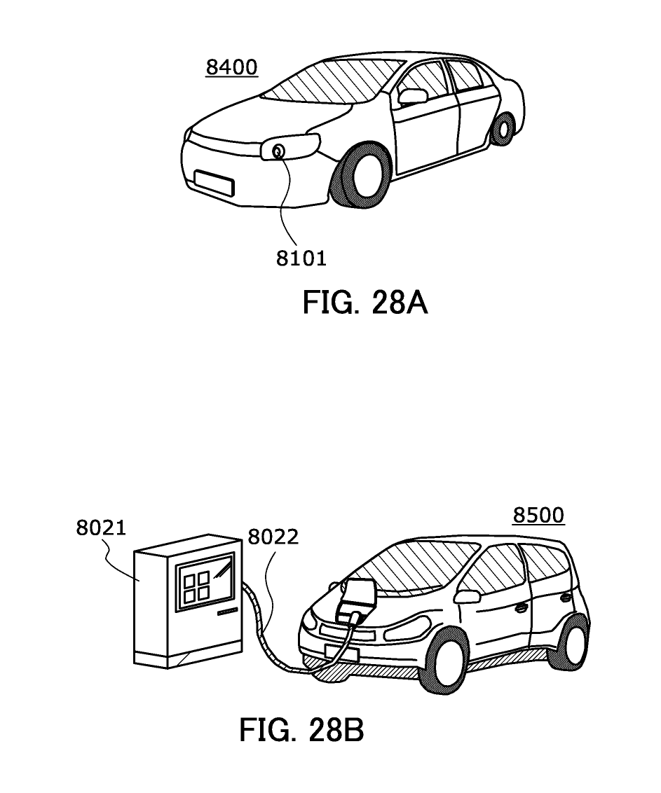

FIGS. 28A and 28B each illustrate an example of a vehicle using one embodiment of the present invention. An automobile 8400 illustrated in FIG. 28A is an electric vehicle which runs on the power of the electric motor. Alternatively, the automobile 8400 is a hybrid electric vehicle capable of driving using either the electric motor or the engine as appropriate. One embodiment of the present invention achieves a high-mileage vehicle. The automobile 8400 includes the power storage device. The power storage device is used not only for driving the electric motor, but also for supplying electric power to a light-emitting device such as a headlight 8401 or a room light (not illustrated).

The power storage device can also supply electric power to a display device included in the automobile 8400, such as a speedometer or a tachometer. Furthermore, the power storage device can supply electric power to a semiconductor device included in the automobile 8400, such as a navigation system.

FIG. 28B illustrates an automobile 8500 including the power storage device. The automobile 8500 can be charged when the power storage device is supplied with electric power through external charging equipment by a plug-in system, a contactless power supply system, or the like. In FIG. 28B, the power storage device included in the automobile 8500 is charged with the use of a ground-based charging apparatus 8021 through a cable 8022. In charging, a given method such as CHAdeMO (registered trademark) or Combined Charging System may be referred to for a charging method, the standard of a connector, or the like as appropriate. The charging apparatus 8021 may be a charging station provided in a commerce facility or a power source in a house. For example, with the use of a plug-in technique, a power storage device included in the automobile 8500 can be charged by being supplied with electric power from outside. The charging can be performed by converting AC electric power into DC electric power through a converter such as an AC-DC converter.

Although not illustrated, the vehicle may include a power receiving device so as to be charged by being supplied with electric power from an above-ground power transmitting device in a contactless manner. In the case of the contactless power supply system, by fitting the power transmitting device in a road or an exterior wall, charging can be performed not only when the automobile stops but also when moves. In addition, the contactless power supply system may be utilized to perform transmission/reception between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Moreover, the power storage device included in the vehicle can be used as a power source for supplying electric power to products other than the vehicle. In that case, the use of a commercial power supply can be avoided at peak time of electric power demand.

### REFERENCE NUMERALS

10: opening; 11: positive electrode current collector, 11a: tab, 12: positive electrode active material layer, 20: opening, 21: negative electrode current collector, 21a: tab, 22: negative electrode active material layer, 30: sheet, 30a: portion, 31: bonding portion, 32: bonding portion, 33: bonding portion, 34: bonding portion, 40: depression, 41: bonding portion, 42: bonding portion, 43: bonding portion, 44: bonding portion, 45: bonding portion, 46: bonding portion, 47: bonding portion, 50: opening, 70: film, 72: introduction port, 100: power storage unit, 101: positive electrode, 102: negative electrode, 103: electrolyte solution, 104: positive electrode lead, 105: negative electrode lead, 106: sealant layer, 107: exterior body, 110: positive electrode plate, 111: positive electrode plate, 112: positive electrode plate, 113: positive electrode plate, 120: negative electrode plate, 121: negative electrode plate, 122: negative electrode plate, 130: envelope body, 131: envelope body, 132: envelope body, 133: envelope body, 133a: film, 140: fixing member, 141: fixing member, 190: power storage unit, 200: power storage unit, 201: bonding die, 202: bonding die, 203: projections, 210: connection region, 220: bent portion, 290: power storage unit, 291: power storage unit, 300: power storage unit, 301: power storage unit, 310: power storage unit, 311: power storage unit, 320: power storage unit, 321: power storage unit, 7100: portable display device, 7101: housing, 7102: display portion, 7103: operation button, 7104: power storage unit, 7200: portable information terminal, 7201: housing, 7202: display portion, 7203: band, 7204: buckle, 7205: operation button, 7206: input output terminal, 7207: icon, 7300: display device, 7304: display portion, 7400: mobile phone, 7401: housing, 7402: display portion, 7403: operation button, 7404: external connection port, 7405: speaker, 7406: microphone, 7407: power storage unit, 8000: display device, 8001: housing, 8002: display portion, 8003: speaker portion, 8004: power storage device, 8021: charging apparatus, 8022: cable, 8100: lighting device, 8101: housing, 8102: light source, 8103: power storage device, 8104: ceiling, 8105: wall, 8106: floor, 8107: window, 8200: indoor unit, 8201: housing, 8202: air outlet, 8203: power storage device, 8204: outdoor unit, 8300: electric refrigerator-freezer, 8301: housing, 8302: door for refrigerator, 8303: door for freezer, 8304: power storage device, 8400: automobile, 8401: headlight, 8500: automobile, 9600: tablet terminal, 9625: switch, 9626: switch, 9627: power switch, 9628: operation switch, 9629: fastener, 9630: housing, 9630a: housing, 9630b: housing, 9631: display portion, 9631a: display portion, 9631b: display portion, 9632a: region, 9632b: region, 9633: solar cell, 9634: charge and discharge control circuit, 9635: power storage unit, 9636: DC-DC converter, 9637: converter, 9638: operation key, 9639: button, 9640: movable portion.

This application is based on Japanese Patent Application serial no. 2013-237205 filed with Japan Patent Office on Nov. 15, 2013, the entire contents of which are hereby incorporated by reference.

1. A power storage device comprising:
an electrode with an opening; and
an insulating sheet covering the electrode,
wherein a part of the insulating sheet is in contact with another part of the insulating sheet in the opening.

2. The power storage device according to claim 1, wherein the insulating sheet is folded in two to envelop the electrode.

3. The power storage device according to claim 1, wherein the insulating sheet comprises two sheets.

4. The power storage device according to claim 1, wherein the part of the insulating sheet is bonded to the another part of the insulating sheet in the opening.

5. The power storage device according to claim 1,
wherein the electrode comprises a protruding portion, and
wherein the protruding portion has a curved shape.

6. A power storage device comprising:
a first electrode with a first opening;
a second electrode; and
a first insulating sheet folded in two to envelop the first electrode,
wherein a part of the first insulating sheet is in contact with another part of the first insulating sheet in the first opening.

7. The power storage device according to claim 6, wherein the part of the first insulating sheet is bonded to the another part of the first insulating sheet in the first opening.

8. The power storage device according to claim 6,
wherein the first electrode is a positive electrode, and
wherein the second electrode is a negative electrode.

9. The power storage device according to claim 6,
wherein the first electrode is a negative electrode, and
wherein the second electrode is a positive electrode.

10. The power storage device according to claim 6,
wherein the second electrode has a second opening.

11. The power storage device according to claim 10, further comprising:
a second insulating sheet covering the second electrode,
wherein a part of the second insulating sheet is in contact with another part of the second insulating sheet in the second opening.

12. The power storage device according to claim 10, wherein the first opening and the second opening overlap with each other.

13. A power storage device comprising:
a first electrode with a first opening;
a second electrode; and
two first insulating sheets enveloping the first electrode,
wherein a part of one of the two first insulating sheets is in contact with a part of the other of the two first insulating sheets in the first opening.

14. The power storage device according to claim 13, wherein the part of one of the two first insulating sheets is bonded to the part of the other of the two first insulating sheets in the first opening.

15. The power storage device according to claim 13,
wherein the first electrode is a positive electrode, and
wherein the second electrode is a negative electrode.

16. The power storage device according to claim 13,
wherein the first electrode is a negative electrode, and
wherein the second electrode is a positive electrode.

17. The power storage device according to claim 13,
wherein the second electrode has a second opening.

18. The power storage device according to claim 17, further comprising:
a second insulating sheet covering the second electrode,
wherein a part of the second insulating sheet is in contact with another part of the second insulating sheet in the second opening.

19. The power storage device according to claim 17, wherein the first opening and the second opening overlap with each other.
